(19) United States
(12) Patent Application Publication
(10) Pub. No.: US 2004/0243588 A1
(43) Pub. Date: Dec. 2, 2004

(54) Systems and methods for administering a global information database

(76) Inventors: Thomas Tanner, Carson City, NV (US); Susan Halpert Hodder, Alpharetta, GA (US); Ravi Raghavan, Alpharetta, GA (US); Guru Chandar, Alpharetta, GA (US); Sal Carannante, BuFord, GA (US); Nader Mir, Alpharetta, GA (US)

Correspondence Address: JOHN S. PRATT, ESQ, KILPATRICK STOCKTON, LLP, 1100 PEACHTREE STREET, ATLANTA, GA, 30309, US

(21) Appl. No.: 10/447,788

(22) Filed: May 29, 2003

(51) Int. Cl. G06F 7/00

(52) U.S. Cl. 707/100

(57) ABSTRACT

The invention includes systems and methods for administering a global information database. A system in accordance with various embodiments of the invention is a global information database system for administering customer inquiry requests for information. The system includes a grey data enrichment module adapted for searching a network for relevant information to a predefined query; generating an abstract containing a portion of relevant information located on the network; and storing a record including the abstract and location information of the relevant information in an associated data storage device. The system can also include a first-type module adapted for receiving an old-type inquiry request; cleansing the old-type inquiry request; and reformatting the old-type inquiry request into a new-type inquiry request. The system also includes a second-type module adapted for receiving a new-type inquiry request from either a customer or the first-type module; matching a name associated with the inquiry request to one or more records in the data storage device; generating a crunch file of initial potential matches to the inquiry request; filtering the initial potential matches to remove any false positives; analyzing the crunch file to remove any other false positives; and generating an alert to the customer if any positive matches exist.

### FIELD OF THE INVENTION

The invention is directed generally to systems and methods for processing information, and more specifically to systems and methods for administering a global information database.

### BACKGROUND OF THE INVENTION

Reliability and creditworthiness of those with whom a business deals are major risk and success factors. Accurate assessment of these factors is of paramount importance, particularly in a global economy where financial partners, clients, employees, suppliers and customers may be individuals or businesses who are located on another continent or otherwise unknown. Accordingly, potentially thousands of institutions involving billions of accounts, relationships, and transactions require at least some form of due diligence, monitoring or surveillance, or regulatory reporting in the management of these risks. National security, legislative and enforcement initiatives as well as conventional and online media highlight the magnitude of many of these risks and arguably obligate businesses to exercise greater care than ever in order to ensure that those with whom they transact are reliable and creditworthy.

Paradoxically, the increasing availability of data and information about reliability and creditworthiness of individuals and businesses increases the difficulty of aggregating and assessing the relevant about any one particular individual or business. Greater volumes of information are being generated and maintained in greater numbers of databases around the world, which renders the task of accessing all relevant information increasingly formidable.

The plethora of forms in which information about individuals and businesses is collected and stored adds to the complexity of retrieving an integral, accurate set of information about a particular person or business. Consider name alone: Records relevant to an individual named Joseph S. Doaks may list him by that name or as Joe Doaks, Joseph Sibelius Doaks, J. Sibelius Doaks, J. S. Doaks, or J. Doaks. With respect to businesses, the problem can be more complex, since the precise legal form of the business is often the subject of minimal attention. Thus, information captured in a database from a newspaper clipping may list the QRZ Distributing, Inc. as QRZ Distributing Company, QRZ Dist. Co., QRZ Distributing, or according to other variations. The problem is compounded when variations on address and other identifiers are taken into account. Formatting and spelling variations and errors add another degree of complexity.

Additional complexity arises from the fact that individuals and businesses change their circumstances constantly. When an individual moves her residence, some databases continue to maintain information about her at her old address, and some at her new. Credit card relationships, telephone numbers, marriages, and many other events cause the data stored on an individual to vary over time for the same individual. Data stored about business face similar degrees of changes, even if for different reasons, such as reorganizations, mergers, acquisitions, typically shorter life spans than individuals, location moves and other reasons.

These variations in data about a particular individual or business over time reduce the certainty of the results of searching databases for information relevant to that individual or business. For example, is the J. S Doaks listed in a database as residing at 1234 Your Street in Anytown, Pa., USA the same individual as Joe Doaks listed in the same or a different database as residing in PA? It may not, without further information, be possible to determine whether the two records relate to the same individual.

The complexity is multiplied by the additional number of records which must be considered in searching and drawing inferences about individuals and businesses with common names such as, for example, John Smith or the Smith Company. Not only do the variations in how the names and other identifying information are entered in multiple databases for different reasons and according to different rules and formats come into play, as well as multiple records which may reflect various different addresses, telephone numbers and other circumstances. With this additional issue, the searcher must distinguish among and draw inferences about multiple actual entities about each of whom the data occurs in multiple forms and formats. Thus, a search for John Public Smith who lives in Allentown, Pa. may retrieve 15 John Smiths who live in Pennsylvania, some or all of with records may be relevant to the actual individual about whom the information is being searched. Further complexity stems from the fact that data about an individual is increasingly frequently stored in multiple languages.

The task is even more difficult for large companies which include multiple operating groups, business units, subsidiaries and affiliates that individually administer and monitor information database systems. Such database systems may be inhibited from sharing information with each other due to legal restrictions on sharing of information between operating groups or subsidiaries for conflicting purposes, such as for insurance, brokerage and medical purposes. They may in any event store different information for different purposes, even if relating to the same individuals, businesses, or group of individuals or businesses.

Brevity of the information with which the search query about an individual or business is or can be formulated is an additional complicating factor. For instance, Mary Smith, an applicant for a brokerage account, may be required to list only name, residence and telephone phone number. That limited set of information may be inadequate to determine whether, for example, records for Mary Smith at another address in another state are relevant, since Mary's address may have changed over time.

Approaches for addressing the uncertainty in which records which relate to a particular individual or business about whom a search for information is being conducted in a database or group of databases involves human intervention. In short, an automated string search, Boolean search or other type of search may be conducted on the databases using a set of search parameters such as name, address and telephone number. The search produces a list of potentially relevant records which is examined by a human specialist who rules out at least some of the records based on various rules and application of experience and intelligence. This human intervention costs time and money, among other things, even when it relates to a relatively short list of records.

These human-intensive inferencing approaches have proved tolerable for conventional searches across a manageable group of databases, particularly when the customer requesting the search requires substantially less than 100% accuracy and reliability. However, as databases become more ubiquitous and as the economy globalizes, a search for information about a particular individual or business may produce lists of records so lengthy that they would overwhelm human agents, if not prove temporally or financially unfeasible to filter down to meaningful results from which business decisions could be made.

### SUMMARY OF THE INVENTION

Systems and processes according to various aspects and embodiments according to the invention address some or all of these issues and combinations of them. They do so by automating at least some of the inference drawing process that is used to reduce a set or records returned from a database search to a set that with a predetermined or acceptable degree of confidence or certainty constitute those records that relate to the particular individual or business being searched. Such systems and processes are particularly useful for databases which seek to aggregate information about virtually every possible person on the planet from a plethora of commercial and governmental databases around the world.

One aspect of systems and processes according to various embodiments of the invention, focuses on administering a database or databases that contain records having generally to do with reliability and creditworthiness of a large number of individuals and businesses in many countries and jurisdictions. For purposes of this document, such databases are referred to as a “global information database.” The potential to obtain information from such databases is increasingly more important to commercial entities as securities brokers, retail and commercial banks, investment and merchant banks, private equity firms, asset management/mutual fund companies, hedge fund firms, insurance companies, credit card issuers, retail and commercial financiers, securities exchanges and other regulators, money transfer agencies, goods and services providers, employers, governmental agencies, and others who need to know information about those with whom they deal.

The need to know more about a large number of people and businesses around the globe gets more interesting and complex as the economy globalizes and the number and size of data sources proliferate. The fact that such data is now stored in various locations and databases can, among other things, increase financial and legal exposure of firms who do not exercise reasonable care in learning about those with whom they deal. Yet the task of aggregating information from the plethora of sources and then obtaining reasonably accurate information about a particular person or business can seem overwhelming. The number of sources from which data in a global information database originates or is sourced is in and of itself formidable. They include some or all of enforcement proceedings records such as governmental and securities exchange records, records maintained by various governmental agencies such as, in the United States, for instance, state and federal agencies (including Department of Commerce, EPA, FTC, FCC, FRB, GSA, Federal Procurement Program records, Justice Department, Treasury, Comptroller Fraud Alerts, Customs, Secret Service, Inspector General, HHS, Federal and state criminal litigation records), media news articles and records, World Bank records, European Union records, FINCEN records, Interpol records, and lists of Politically Connected Persons. Such databases are created and grow every day, along with the need and the complexity of obtaining useful, coherent, useful and accurate information from them about particular persons or businesses of interest.

Various embodiments of systems and processes according to the invention include new and useful database aggregation or amalgamation, searching and filtering technology in order to automate the task of keeping abreast of information of the sort that can comprise a global information database or databases. Such technology includes new ways to abstract, enrich, process and organize such data for storage in global information database functionality; new and dynamic ways to handle and modify records as they are searched in order to make them more useful and relevant for the next search; successive or staged filtering techniques to eliminate false positive returned records in a search; and new ways to generate alert lists based on a request by a customer to “watch” a particular individual or business.

According to one aspect of systems and processes according to various embodiments of the invention, information from a variety of sources including governmental agencies, private entities, media information such as newspaper articles, web content and emails, and other information is abstracted and enriched in an automated fashion to enhance usefulness and accessibility of corresponding records in the database, among other things. Such enrichment can include creation and application of key words and phrases, artificial intelligence rules and processes, neural networking techniques, Boolean logic rules, symbols or operators, pointers, metadata, interpretation and imaging, among other varieties.

According to another aspect of systems and processes according to various embodiments of the invention, automated filtering occurs based on inferencing rules, logic and/or other techniques and data. Such systems and processes apply isolation processes to raw sets of data to determine name-related information in the data for subsequent matching and comparison purposes. Further, such systems and processes apply filtering or other inferencing processes to sets of data returned from a search in order to rule out records which at least superficially appear to be relevant but are not actually relevant to the individual or business about whom the search is being conducted. Such inferencing can occur based on name and/or gender; social security number, state and/or region; company name matching; and duplicate records, among other inferencing processes. For instance, a set of records returned from a search on an individual or business may be winnowed considerably by automatically ruling out duplicates of a record.

One particular method for administering a global information database according to one aspect of systems and processes of various embodiments of the invention includes gathering information from multiple data sources into a global information database, including information from a financial information database, a media information database, and an enforcement information database. The method further includes receiving an inquiry request from a customer; comparing a name associated with the inquiry request to one or more records in the global information database; generating a file of initial potential matches to the inquiry request; filtering the initial potential matches to remove at least some false positives; analyzing the file to remove at least some false positives; and communicating an alert to the customer if at least some positive matches exist.

According to another aspect of systems and processes according to various embodiments of the invention, a global information database is operated upon by a system for abstracting, enriching, processing and storing incoming information. Such information can be gathered automatically by automatic web search and retrieval techniques (including so-called “bots”), review of electronic mail functionality, review and scanning of newspaper and other media sources, among others. A particular such system includes a so-called grey data enrichment module adapted to generate an abstract relating to and/or otherwise enriching at least a portion of such relevant information, and storing a record including or corresponding to the abstract and location information of the relevant information in an associated data storage device.

Systems and processes according to various embodiments of the invention can also, but need not, include two or more processing paths. Such paths can be used to add database and processing functionality to an already existing database, among other things. For instance, a conventional or first-type module may be adapted for receiving a conventional or first-type inquiry request; cleansing the conventional inquiry request; and reformatting the conventional inquiry request into a new or second-type inquiry request. This particular system also includes a second-type or, in this case a global information, module adapted for receiving a second-type inquiry request from either a customer or the first-type module; matching a name associated with the inquiry request to one or more records in the database; generating a file of initial potential matches to the inquiry request; filtering the initial potential matches to remove some or all false positives; analyzing the file to remove other false positives; and generating an alert to the customer if any positive matches exist.

According to another aspect of the invention, systems and processes according to various embodiments of the invention can administer an inquiry request to a global information database. Such systems and processes can include gathering information from multiple data sources into a global information database, including information from a financial information database, a media information database, and an enforcement information database; receiving an inquiry request from a customer; comparing a name associated with the inquiry request to one or more records in the global information database; generating a file of initial potential matches to the inquiry request; filtering the initial potential matches to remove at least some false positives; analyzing the file to remove at least some false positives; and communicating an alert to the customer if at least some positive matches exist.

According to another aspect of the invention, systems and processes according to various embodiments of the invention can filter information in response to an inquiry request to a global information database. Such systems and processes can include determining whether an inquiry request is associated with a person's name or a business name; gathering information from multiple data sources into a global information database, including information from a financial information database, a media information database, and an enforcement information database; searching the global information database for potential matching records to the inquiry request; eliminating potential matching records based on whether they are a person's name or a business name; storing potential matching records in a file; filtering potential matching records and removing at least some false positives from the file based upon a filter; and analyzing the file to remove at least some false positives.

According to another aspect of the invention, systems and processes according to various embodiments of the invention can collect information for a global information database. Such systems and processes can include searching multiple data sources for relevant information, including information from a financial information database, a media information database, and an enforcement information database; generating an abstract including a portion of relevant information located from at least one of the data sources; and storing a record including the abstract and location information of the data source with the relevant information.

According to another aspect of the invention, systems and processes according to various embodiments of the invention can alert a customer in response to an inquiry request to a global information database. Such systems and processes can include gathering information from multiple data sources into a global information database, including information from a financial information database, a media information database, and an enforcement information database; searching the global information database for potential matching records to an inquiry request; filtering potential matching records and removing at least some false positives; determining a positive matching record in the global information database to the inquiry request; and communicating an alert to the customer including a portion of information from the positive matching record.

According to another aspect of the invention, systems and processes according to various embodiments of the invention can monitor an inquiry request to a global information database. Such systems and processes can include receiving a watch list item corresponding to an inquiry request received from a customer; detecting a record in a database matching the watch list item; generating a file of initial potential matches to the watch list item; filtering the initial potential matches to remove at least some false positives; analyzing the file to remove at least some false positives; and communicating an alert to the customer if at least some positive matches exist.

According to another aspect of the invention, systems and processes according to various embodiments of the invention can alert multiple entities associated with a customer precluded from sharing information among at least some of the multiple entities. Such systems and processes can include gathering information from multiple databases into a global information database; receiving inquiry requests from at least some of the multiple entities; searching the global information database for potential matching records to the inquiry requests; filtering potential matching records and removing at least some false positives; determining positive matching records in the global information database to the inquiry requests; and communicating a respective alert including a portion of information from the positive matching records to at least some of the multiple entities.

According to another aspect of the invention, systems and processes according to various embodiments of the invention can include a grey data enrichment module adapted to gather information from multiple data sources into a global information database, including information from a financial information database, a media information database, and an enforcement information database. The system further includes a global information database module adapted to receive an inquiry request from a customer; compare a name associated with the inquiry request to one or more records in the global information database; generate a file of initial potential matches to the inquiry request; filter the initial potential matches to remove at least some false positives; analyze the file to remove at least some false positives; and communicate an alert to the customer if at least some positive matches exist.

Objects, features and advantages of various systems and processes according to various embodiments of the present invention include:

(1) providing improved ability to aggregate, process, abstract, enrich and store in a useful and effective manner massive amounts of information about particular individuals and business around the globe, which information is created and stored in a large number of databases, media, locations and languages;

(2) providing improved ability to search such information and provide meaningful results about particular individuals and businesses;

(3) providing new ways to update and enhance data stored in such databases dynamically and otherwise in order to improve results on future searches;

(4) providing enhanced ability to perform watches and alerts relating to new developments in the affairs of particular individuals and businesses;

(5) providing modular systems and processes which have the ability to automate filtering of search results, in successive stages or otherwise, in an easily changeable and reprogrammable manner, in order to draw and apply inferences, eliminate false positive results or results below certain predetermined confidence levels, and produce meaningful, useful and accurate results about particular individuals and businesses; and

(6) providing enhanced ability to view, track, sort, and analyze search results in order to eliminate false positive results or results below certain predetermined confidence levels, and produce meaningful, useful and accurate results about particular individuals and businesses.

Other objects, features and advantages will become apparent with respect to the remainder of this document.

### BRIEF DESCRIPTION OF THE DRAWINGS

FIG. 1 is a process flow diagram for a system and method in accordance with various embodiments of the invention.

FIG. 2 is a functional block diagram for a system in accordance with various embodiments of the invention.

FIG. 3 is a flowchart for a method in accordance with various embodiments of the invention.

FIG. 4 is a flowchart for a subroutine of the method shown in FIG. 2.

FIG. 5 is a flowchart for another subroutine of the method shown in FIG. 2.

FIG. 6 is a flowchart for another subroutine of the method shown in FIG. 2.

FIG. 7 is a flowchart for another method in accordance with various embodiments of the invention.

FIG. 8 is a flowchart for another method in accordance with various embodiments of the invention.

FIG. 9 is a flowchart for another method in accordance with various embodiments of the invention.

FIG. 10 is a functional block diagram for another system in accordance with various embodiments of the invention.

FIG. 11 is a flowchart for another method in accordance with various embodiments of the invention.

FIG. 12 is a screen shot for a website associated with a system and method in accordance with various embodiments of the invention.

FIG. 13 is another screen shot for a website associated with a system and method in accordance with various embodiments of the invention.

FIG. 14 is another screen shot for a website associated with a system and method in accordance with various embodiments of the invention.

FIG. 15 is another screen shot for a website associated with a system and method in accordance with various embodiments of the invention.

FIG. 16 is another screen shot for a website associated with a system and method in accordance with various embodiments of the invention.

### DETAILED DESCRIPTION OF SPECIFIC EMBODIMENTS

Systems and processes according to various aspects and embodiments according to the present invention address some or all of the previously described issues and combinations of them. They do so by automating at least some of the inference drawing process that is used to reduce a set or records returned from a database search to a set that with a predetermined or acceptable degree of confidence or certainty constitute those records that relate to the particular individual or business being searched. Such systems and processes are particularly useful for databases which seek to aggregate information about virtually every possible person on the planet from a plethora of commercial and governmental databases around the world.

Generally described, one aspect of the invention provides a method for administering a global information database. The method includes receiving an inquiry request from a customer; matching a name associated with the inquiry request to one or more records in a database; generating a crunch file of initial potential matches to the inquiry request; filtering the initial potential matches to remove any false positives; analyzing the crunch file to remove any other false positives; and communicating an alert to the customer if any positive matches exist.

More particularly described, an aspect of the invention provides a global information database system for administering customer inquiry requests for information. The system includes a grey data enrichment module adapted for searching a network for relevant information to a predefined query; generating an abstract containing a portion of relevant information located on the network; and storing a record including the abstract and location information of the relevant information in an associated data storage device. The system can also include a conventional or first-type module adapted for receiving a conventional or an old-type inquiry request; cleansing the old-type inquiry request; and reformatting the old-type inquiry request into a new-type inquiry request. The system also includes a second-type, or global information, module adapted for receiving a new, second-type inquiry request from either a customer or the first-type module; matching a name associated with the inquiry request to one or more records in the data storage device; generating a crunch file of initial potential matches to the inquiry request; filtering the initial potential matches to remove any false positives; analyzing the crunch file to remove any other false positives; and generating an alert to the customer if any positive matches exist.

In this specification, the term “inquiry request” is defined as a request received from a customer for information regarding a third-party. An inquiry request can include, but is not limited to, a person's name, a business or company name, an entity name, in combination with location information such as city, state, or zip code; or unique numerical identification information such as a social security number, a federal tax ID number, an account number, a date of birth, or an age of the person; or unique personal information such as the name of a spouse or maiden name; or any other personal identification information or business identification information. An inquiry request may be associated with initiating a new account registration with a customer. That is, when a third-party initiates a new account with a customer, a name or other information associated with the third-party can be part of an inquiry request that is automatically transmitted by the customer or a system associated with the customer to the invention for processing.

Furthermore, the term “customer” is defined as an entity initiating an inquiry request. That is, a customer is an entity that is interested in obtaining information from or otherwise interested in searching information stored by the invention. The customer ultimately receives an output from or services associated with an output from the invention. A customer may be a financial institution, a brokerage, an insurance company, a government administrative agency, an investigative service, or any other entity that desires to track information related to a particular person, name, or entity. Note that a customer, or the entity initiating an inquiry request can either automatically initiate the request by associating any new account registration with initiating an inquiry request, or can manually submit an inquiry request that is automatically or otherwise transmitted to the invention for processing.

The term “global information database” is defined as one or more databases or data sources containing records having generally to do with reliability and creditworthiness of a large number of individuals and businesses in many countries and jurisdictions.

The term “grey record” is defined as information that has been previously gathered, collected, or otherwise received. A “grey record” may be referred to as a “record.” Information regarding a particular person or business from a particular data source can be organized as a “grey record,” and then stored for later retrieval, analysis, transmission, or processing. Records or grey records can be collectively stored in a “grey file” and/or “grey database.”

Finally, the term “alert” is defined as a message or other communication transmitted to a customer in response to an inquiry request by the invention or a person associated with the invention. An “alert” may contain information associated with a grey record.

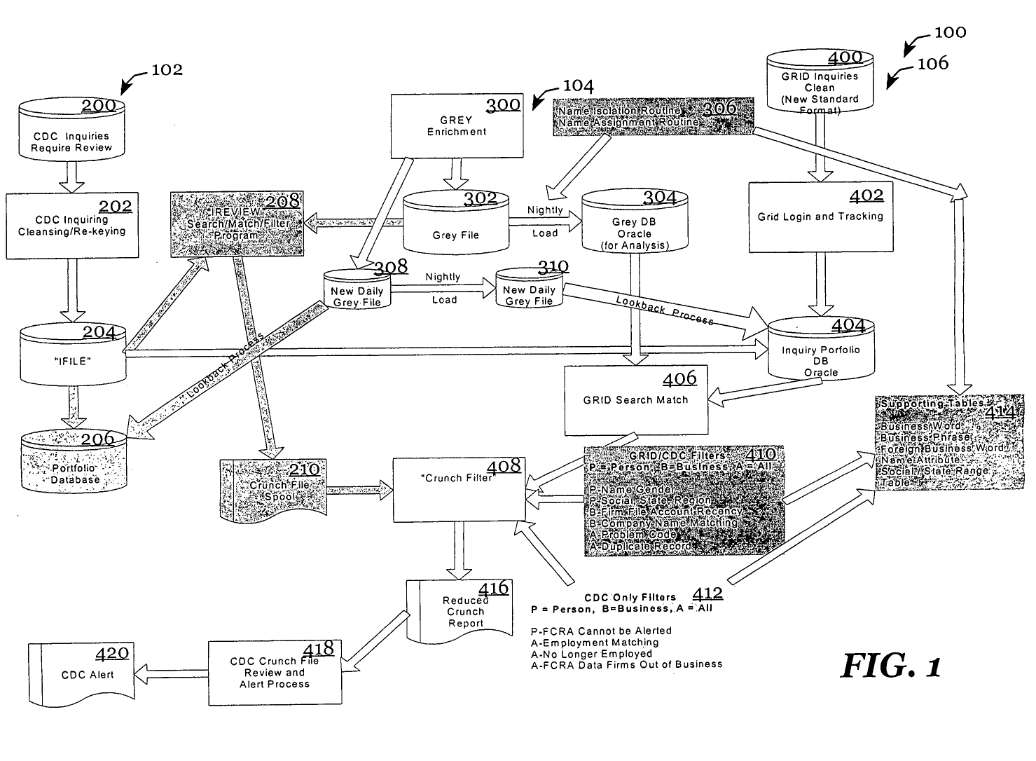

FIG. 1 is a process workflow diagram for a system and method in accordance with various embodiments of the invention. In this diagram, a workflow process 100 for a global information database is shown. The process 100 includes three workflow components: first-type (CDC) 102, grey data enrichment 104, and second-type or global information (GRID) 106. The process 100 can include other workflow components in accordance with the invention.

Generally, the workflow process 100 is adapted to respond to an inquiry request for information from a customer. The process 100 is further adapted to administer a global information database, search the global information database, and match relevant information to the inquiry request. Moreover, the process 100 is adapted to filter initial positive matches to the inquiry request until one or more final positive matches are made. The process 100 is further adapted to alert the customer, and to transmit the final positive match and relevant information in response to the customer's inquiry request. Since numerous records or files in a global information database may contain potential matching information to a customer's inquiry request, the records that are initially identified as containing potential matching information must be further reduced in a relatively efficient manner so that further processing can identify positive matches to the customer inquiry, and the customer can be alerted to these positive matches as soon as possible.

The first-type 102 and second-type 106 workflows process inquiry requests from customers such as financial institutions and brokerages. Typically, an inquiry request is a request for information regarding a third-party such as a person or a business. The inquiry requests are formatted as needed for processing by a series of filters or subroutines. An initial filter or subroutine determines name information contained in each inquiry request, and further determines whether the name information is associated with a person or a business. The inquiry request can be then be appropriately coded and stored for subsequent matching to similar type records in a global database.

The grey data enrichment 104 workflow processes raw information located or otherwise received from multiple data sources. The raw information is processed for relevancy to particular names associated with persons or businesses. Each relevant portion of information associated with a person or a business can be stored as a record in an associated database. Records in the database can then be searched and matched to inquiry requests submitted to and stored by the first-type 102 and second-type 106 workflows.

Initial positive matches to a particular inquiry request are stored in a crunch file. Other subroutines or filters associated with the second-type 106 workflow reduce the number of false positives within the initial positive matches. The remaining records of the crunch file can then be manually analyzed by an alerter or further processed to obtain final positive matches to a customer's inquiry request. An alert can then be generated for a positive match to the customer's inquiry request, and relevant information associated with the record can be transmitted to the customer in association with the alert. In this manner, the first-type (CDC) 102, grey data enrichment 104, and second-type (GRID) 106 workflows cooperate to administer a global information database. With respect to each component of the workflows 102-106 shown in FIG. 1, a brief description of each follows.

The conventional, first-type (CDC) 102 workflow begins in 200. In 200, the first-type 102 workflow receives an inquiry request. Typically, first-type workflow-received inquiry requests are transmitted in an old-type, conventional format. This old-type format must be reformatted or otherwise reviewed prior to transmission to and processing by the second-type 106 workflow.

200 is followed by 202 in which the first-type workflow-received inquiry request is cleansed and/or re-keyed to a new format. The first-type 102 workflow provides processing of the old-type inquiry request to “cleanse” the inquiry request and to format the inquiry request for transmission to and processing by the second-type 106 workflow.

202 is followed by 204, in which the cleansed first-type workflow-received inquiry request is stored in an I-File. Cleansed first-type workflow-received inquiry requests are then transmitted to the second-type 106 workflow, described below in 130.

Note that the first-type 102 workflow is a modification of a conventional workflow for processing an inquiry request. The first-type 102 workflow now operates in conjunction with the grey data enrichment 104 and second-type 106 workflows as shown in FIG. 1. An example of a conventional workflow includes conventional components 206-210, such as a CDC portfolio database 206, IREVIEW Search/Match/Filter Program 208, and Crunch File Spool 210, which are not implemented with the first-type 102 workflow shown here.

The grey data enrichment 104 workflow begins at 300. In 300, the grey data enrichment 104 workflow gathers, collects, or otherwise receives raw information from multiple data sources. The raw information is processed for relevancy to particular names associated with persons or businesses.

300 is followed by 302, in which relevant information associated with a person or a business is stored as a record in a grey file or risk file. Each record in the grey file may be referred to as a “grey record.” Relevant information can include location information such as a link to where relevant information is located on a network, as well as abstract information such as a portion of information that includes relevant keywords, phrases, or portions of an electronic document or article. Each record in the grey file can be later retrieved for analysis, transmission, or further processing.

Between 302 and 304, the records are subjected to a series of name isolation/assignment routines 306. The name isolation/assignment routines 306 can be a set of computer-executable instructions or filters designed to isolate and determine name information in a record, and further determine whether name information is associated with a person or a business. As each record is processed through the name isolation/assignment routines 306, Each record can then be appropriately coded for later reference during record searching and matching processes implemented by the second-type 106 workflow.

In 304, in which the records are transmitted from the grey file to a grey database during a nightly load. A nightly load can occur at any predefined time in a particular day, week, month, or other time period. Records transmitted to the grey database can then be searched and matched to inquiry requests processed by the second-type 106 workflow, described below in 406.

Referring back to 300, the grey data enrichment 104 workflow also collects or receives data for a lookback process for previously stored inquiry requests. In 300, recent or new data collected by or otherwise received by the grey data enrichment 104 workflow is stored in a new daily grey file in 308. Recent or new data is stored in the new daily grey file in a record-format.

Records stored in the new daily grey file in 308 are also subjected to a series of name isolation/assignment routines 306, similar to those between 302 and 304, and described above. The name isolation/assignment routines 306 can be a set of computer-executable instructions or filters designed to isolate and determine name information in the record, and further determine whether the name is associated with a person or a business. The record can then be appropriately coded for later reference during record searching and matching processes implemented by the second-type 106 workflow.

308 is followed by 310, in which the recent or new data is transmitted to a new daily grey file associated with the second-type 106 workflow during a nightly load. Records in the new daily grey file associated with the second-type 106 workflow can then be searched and matched to inquiry requests in a lookback process implemented by the second-type 106 workflow, described below in 404.

The second-type or global information (GRID) 106 workflow begins at 400. In 400, an inquiry request is received from a customer. The second-type 106 workflow receives second-type or new-type inquiry requests from customers such as financial institutions or brokerages. Typically, the new-type inquiry requests are received in a new, standard format. An inquiry request contains at least a portion of the following information: social security number, last name, first name, spouse name, account number, address information, or other unique identifying information. As described in 204, the first-type 102 workflow transmits cleansed inquiry requests to the second-type 106 workflow for further processing. The first-type workflow-received inquiry requests are received at 400 after cleansing by the first-type 102 workflow. After 400, new-type inquiry requests and cleansed inquiry requests are similarly processed by the second-type 106 workflow.

Each inquiry request is subjected to a series of name isolation/assignment routines, similar to 306. The name isolation/assignment routines or filters are designed to isolate name information in the inquiry request, determine name information in the inquiry request, and further determine whether the name is associated with a person or a business. The inquiry request can then be appropriately coded for later reference during inquiry request searching and matching processes implemented by the second-type 106 workflow.

400 is followed by 402, in which the customer is logged in and the customer's transactions with the second-type 106 workflow can be tracked for future billing purposes.

402 is followed by 404 in which the inquiry request is stored in an inquiry request portfolio database. The inquiry request portfolio database can include a portfolio of one or more stored inquiry requests for each customer being administered by the second-type 106 workflow. Each inquiry request is stored in a record-type format. A particular inquiry request or a customer may desire to have a watch list of names or items that is updated on a regular or periodic basis. Using the watch list, the second-type 106 workflow implements a lookback process with the grey data enrichment 104 workflow to provide an update of one or more previously stored inquiry requests in the inquiry portfolio database.

404 is followed by 406, in which a Global Information Database Search/Match process is implemented. The Global Information Database Search/Match process includes a search/match subroutine. In the search/match subroutine, the grey database of 304 is searched for potential matches to a particular inquiry request. The initial search locates records that are similar type records, such as person or business records, and also locates records containing similar or matching keywords or phrases. Keywords or phrases can be predefined portions of information in an inquiry request, grey record, or record. Initial matching records are also known as “initial positive matching” records.

406 is followed by 408, in which the initial matching records are processed by a one or more crunch filters or subroutines. Typically, initial matching records are stored in a crunch file for further processing by a series of crunch filters or subroutines. One or more crunch filters or subroutines are applied to the initial matching records in the crunch file at 408. Specific filters or subroutines are applied to initial matching records depending whether the records are generally associated with a person, a business, or both. As shown in 410, records processed by the first-type 102 and/or second-type 106 workflows are filtered by subroutines such as Name Gender, Social/State/Region, Firm File Account Recency, Company Name Matching, Problem Code, and Duplicate Record. Other filters or subroutines can exist.

In some instances, records in the grey database were previously stored by a conventional workflow. These records include information that can be filtered by subroutines in 410 and 412. These subroutines can include, but are not limited to, FCRA Cannot Be Alerted, Employment Matching, No Longer Employed, and FCRA Data Firms Out of Business. Other filters or subroutines can exist. Again, specific filters or subroutines are applied to initial matching records depending whether the records are generally associated with a person, a business, or both.

Note that in 414, one or more supporting tables can be referenced by the subroutines or filters described in 410 and 412. Furthermore, these supporting tables can also be referenced by the name isolation/assignment filters or subroutines described with respect to the coded inquiry requests and records. Typically, a database or data storage device supports access to one or more supporting tables. A supporting table is a collection of information that is comprehensive or selected list of words, terms, or other information in a particular category that can be compared to a corresponding word, term, or piece of information. Information for a supporting table can include, but is not limited to, a Business Word, a Business Phrase, a Foreign Business Word, a Name Attribute, a Social Security Number/State Range, and a Geographic Coding for Country Names. Other supporting tables can exist.

408 is followed by 416, in which remaining records are output to a reduced crunch report. The reduced crunch report is a reduced crunch file containing records that are initial matching records with a relatively higher degree of certainty of being positive matching records. Records that are filtered out by at least one name isolation/assignment filter or subroutine are not included with the reduced crunch report, or can otherwise be designated as containing false positive information.

416 is followed by 418, in which the remaining records in the crunch file are reviewed. The reduced crunch report of 416 can be manually or automatically reviewed and analyzed to remove additional false positive matches, and to further reduce the size of the crunch file or the number of records in the crunch file. Remaining records that are identified to contain positive matching information are considered to be “final positive matches.” The content any final positive matches is typically transmitted to a customer associated with an inquiry request. To do so, an alert process is initiated by the second-type 106 workflow.

418 is followed by 420, in which an alert is generated for transmission to a customer. In response to any final positive matches in 418, the second-type 106 workflow initiates an alert to the customer. An alert can include a message with relevant information contained within the records associated with the final positive matches.

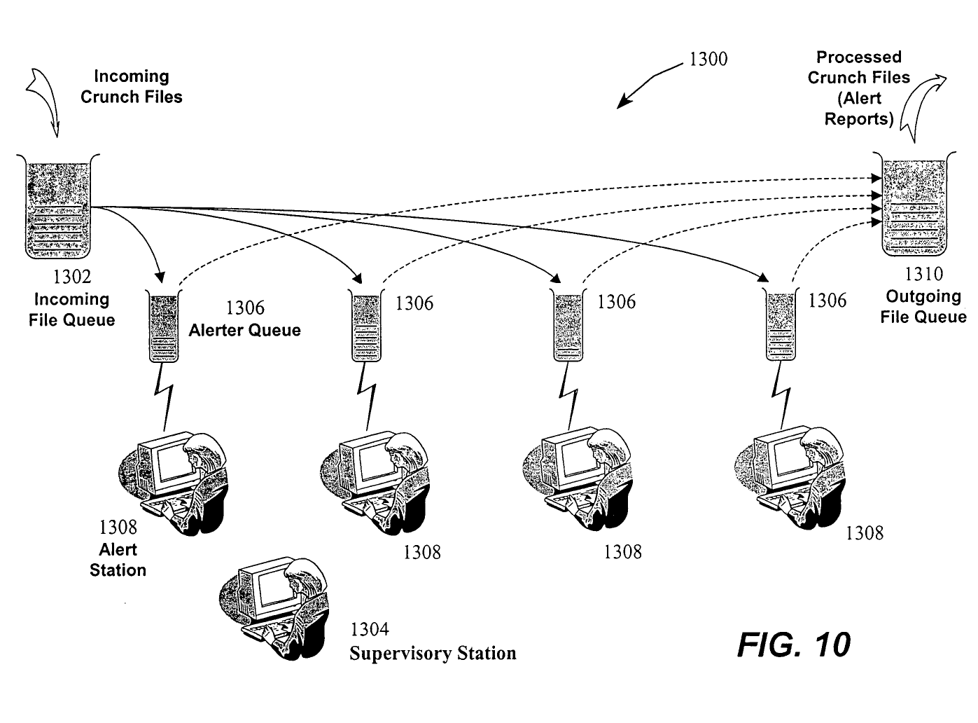

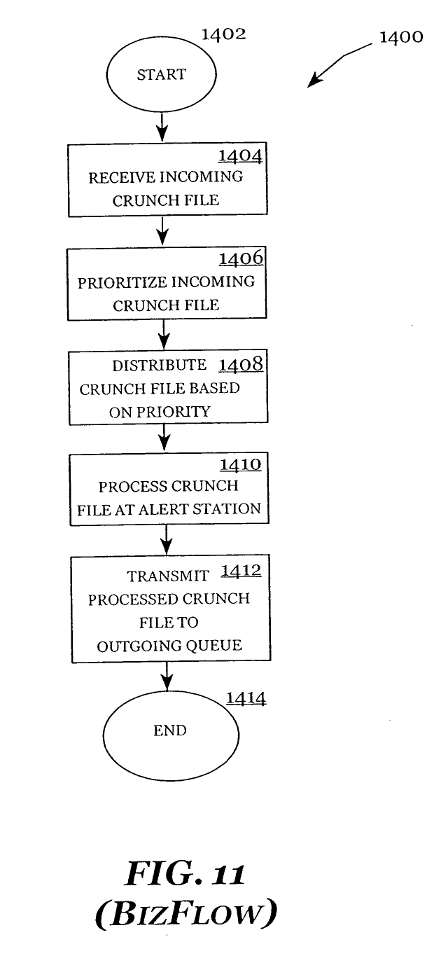

In an environment where there are multiple crunch files corresponding to multiple inquiry requests, an example of a system and method to process, review, and analyze multiple crunch files, and to generate an alert in accordance with various embodiments of the invention is shown in 1300 in FIG. 10, and also in 1400 in FIG. 11.

Each of the three workflow components, first-type (CDC) 102, grey data enrichment 104, and second-type or global information (GRID) 106, can provide other features and functions in accordance with the invention.

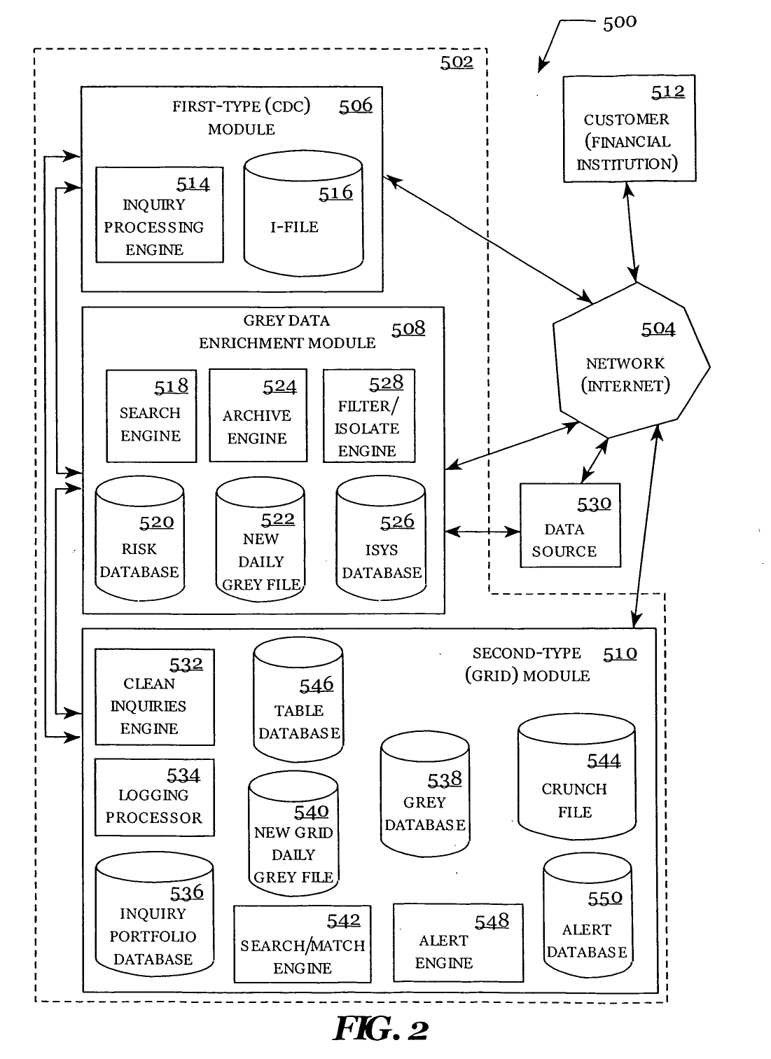

FIG. 2 is a preferred environment 500 for a system 502 in accordance with various embodiments of the invention. Typically, the preferred environment 500 is a network 504 in communication with a system 502 including one or more system modules 506-510 in accordance with the invention. For example, the network 504 can be a distributed network of computers such as the Internet, and the system modules can be a conventional or first-type (CDC) module 506, a grey data enrichment module 508, and a second-type or global information (GRID) module 510. Other system modules operating in accordance with the invention may exist.

Each of the modules 506-510 can be hosted by one or more processor-based platforms such as those implemented by Windows NT/2000 and/or UNIX-based operating platforms. Furthermore, each of the modules 506-510 may utilize one or more conventional programming languages such as DB/C, C, C++, UNIX Shell, and Structured Query Language (SQL) to accomplish methods in accordance with the invention, including system functionality, data processing, and communications between functional components.

The system 502 is adapted to compare an inquiry request from a customer 512 with information that potentially matches the inquiry request, and then the system 502 is further adapted to notify the customer 512 when a potential match to the inquiry request is made. One or more customers 512 typically operate a processor-based platform such as a client (not shown) in communication with the system 500 via the network 504. The system 502 can receive one or more inquiry requests from any number of customers 512 via the network 504. Customers 512 are generally provided access to the system 500 upon prior authorization, via on-line authorization, or optionally, after payment of a fee. A customer 512 that is provided access to the system 502 communicates with the system 500 via the network 504 through either the first-type module 506 or the second-type module 510. Typically, a customer 512 is a financial institution that can communicate via a network 504 such as the Internet. The first-type module 506 handles a different format of inquiry request than the second-type module 510. The first-type module 506 processes conventional, old-type inquiry requests into a new-type inquiry request, and then transmits the reformatted inquiry request to the second-type module 510 for further matching. The second-type module 510 receives new-type inquiry requests, and processes these inquiry requests for matching. In both instances, the inquiry request is stored by the second-type module 510 for potential matching to information received and accessed by the second-type module 510. Information is collected or received by the system 500 via the grey data enrichment module 508. The grey data enrichment module 508 searches for matching and potentially relevant information, stores located information in a record-type format, and archives located information for future retrieval and potential matching to an inquiry request. This information is utilized by the second-type module 510 to compare with and potentially match to reformatted and new-type inquiry requests. Each of the modules 506-510 and their respective functions are described in turn below.

The conventional or first-type (CDC) module 506 includes an inquiry processing engine 514, an inquiry database or I-File 516. The first-type module 506 communicates with one or more customers 512 via a network 504 such as the Internet. When a customer 512 such as a financial institution sends an inquiry request via the network 504, the first-type module 506 receives the inquiry request and processes the inquiry request. The first-type module 506 handles conventional, old-type inquiry requests. These types of conventional, old-type inquiry requests should be further processed by the first-type module 506 prior to communication of a particular inquiry request to the second-type module 510.

Typically, the inquiry processing engine 514 receives an inquiry request from a customer 512 via the network 504. The inquiry processing engine 514 handles the inquiry request and processes the inquiry request for transmission to an inquiry database such as the I-File 516. Generally, the inquiry processing engine 514 includes a set of computer-executable instructions adapted to reformat and process a conventional, old-type of inquiry request received by the first-type module 506. Processing the information inquiry can include “cleansing” the conventional, old-type inquiry request or re-keying the inquiry request into a different format. Typically, an inquiry request received by the first-type module 506 is formatted into a new, standard format. The conventional old-type of format inquiry request must be re-formatted into a new, standard format prior to transmitting and processing the inquiry request by the second-type module 510. The inquiry processing engine 514 reformats conventional old-type of format inquiry requests received by the first-type module 506 into a new, standard format of inquiry request that can be further stored by the I-File 518 or otherwise processed by the second-type module 510. In some instances, pre-existing old-type inquiry requests must also be reformatted by the inquiry processing engine 514. These pre-existing old-type inquiry requests may have been previously supplied by one or more customers 512.

In some instances, a received inquiry request in a conventional old-type of format may have to be completely re-keyed or re-entered into a new, standard format that can be stored in the I-File 516 and later processed by the second-type module 510. Generally, an operator associated with the first-type module 506 or another module can review an inquiry request and re-key or re-type pertinent information from the conventional old-type format inquiry request into a new, standard format that can be stored by the I-File 516 and later processed by the second-type module 510. For example, the inquiry processing engine 514 can include an associated display device (not shown) and input device (not shown) that provides an operator visual access to the conventional old-type inquiry request submitted to the first-type module 506 by a customer 512. The operator can review information associated with the conventional old-type inquiry request, and using the input device such as a keyboard, can re-enter or re-key a portion of the information into a new, standard format for further processing by the inquiry processing engine 514, for storage in the I-File 516, and later processed by the second-type module 510.

The I-File 516 is adapted to store old, “conventional” inquiry requests received from customers 512 as well as receive “cleansed” inquiry requests from the inquiry processing engine 514. The I-File 516 is further adapted to store the “cleansed” inquiry requests or other output from the inquiry processing engine 514. The I-File 516 can be a relational database adapted for storing one or more inquiry requests in a variety of different formats. For example, when an inquiry request is received by the first-type module 506 via the inquiry processing engine 514, the inquiry processing engine 514 stores the inquiry request, such as an old, “conventional” inquiry request, in the I-File 518. The inquiry request can be subsequently retrieved and processed by the inquiry processing engine 514. If a particular inquiry request is re-keyed, re-entered, or otherwise re-formatted, i.e. cleansed, the inquiry processing engine 514 stores the newly formatted inquiry request in the I-File 516.

The grey data enrichment module 508 includes a search engine 518, a risk database 520 or grey file, a new daily grey file 522, an archive engine 524, an image or ISYS database 526, and a filter/isolation engine 528. The grey data enrichment module 508 handles information that is collected or otherwise received by the system 502 via the network 504 from one or more data sources 530, associated databases or data storage devices, or other third-party data sources. The grey data enrichment module 508 is adapted to search for, receive, document, and further process information sent by a data source 530 or otherwise received from a data source 530.

The search engine 518 locates information and either collects or receives information from a data source 530. One or more conventional search engines can be simultaneously utilized or utilized in conjunction with each other by the search engine 518 to locate, receive, and/or retrieve information from one or more data sources 530. The search engine 518 is adapted to utilize one or more keywords, phrases, and/or logical operators in a search query or combination to search for matching information corresponding to the search query or combination of one or more keywords, phrases, and/or logical operators. One or more search queries can be simultaneously executed using different queries or combinations of keywords, phrases, and/or logical operators. When matching information is located, the search engine 518 is adapted to communicate with the archive engine 524 to further process the relevant information. In some instances, the search engine 518 can transmit information to the risk database 520, new daily grey file 522, or another associated database or storage device to store raw information for later retrieval and processing by the archive engine 524.

For example, a search engine 518 can be adapted to search a network 504 such as the Internet, public or private networks, databases, other storage devices, or data sources for relevant information corresponding to a particular query or combination of one or more keywords, phrases, and/or logical operators that is relevant to a received inquiry request from a customer 512. All matching information located by the search engine 518 in accordance with a predefined search query or combination of search terms is then transmitted to the archive engine 524 for further processing.

Generally, a data source 530 such as a third-party source provides or otherwise stores retrievable information. Information retrievable from a third-party source can include, but is not limited to, Fair Credit Reporting Act (FCRA) and non-FCRA related data, published data, customer-supplied data, public information, and private information. For example, public information can include, but is not limited to, newspapers, magazines, trade publications, wire reports, U.S. enforcement agency decisions or actions; international regulatory enforcement decisions or actions; U.S. state or local regulatory enforcement decisions or actions; international and U.S. government department listings; political and military associated individuals; U.S. White House lists of individuals; lists of international high risk geographic regions; Interpol lists; U.S. agency lists of individuals; adverse U.S. and international media coverage; lists of U.S. and international crime organization members and associates. By way of example, private information can include, but is not limited to, proprietary databases hosted by one or more customers, fee-based databases hosted by a commercial provider of news or information.

Information collected by the search engine 518 and/or processed by the archive engine 524 can then be stored in the risk database 520 or in the new daily grey file 522. The risk database 520 and the new daily grey file 522 are both adapted to store one or more unique records including location information in a pointer file and an abstract in an abstract file. Additional details about the type of records, information, and files stored in the risk database 520 and the new daily grey file 522 are disclosed below. Furthermore, the risk database 520 and the new daily grey file 522 are both adapted to communicate with and to transmit information such as a records to the second-type module 510 when needed.

The risk database 520 and the new daily grey file 522 are typically databases or data storage devices adapted for storing information for later retrieval. One difference between the risk database 520 and the new daily grey file 522 is that the risk database 520 is adapted for relatively long-term storage of information, whereas the new daily grey file 522 is adapted for relatively short-term storage of information. A difference between the type of information stored in the risk database 520 and the new daily grey file 522 is the recency of the information. That is, information that has been collected in a prior immediate time frame is stored in the new daily grey file 522, whereas information stored in the risk database 520 was collected and stored prior to time frame of the information stored in the new daily grey file 522. For example, third-party information previously collected by the first-type module 506 is stored in the risk database 520.

The risk database 520 and new daily grey file 522 typically contain both FCRA information and non-FCRA information. Prior to transmission of this type of information from the grey data enrichment module 506 to the second-type module 510, the filter/isolate engine 528 filters the information accordingly.

Information in the new daily grey file 522 can be transmitted to and stored by the second-type module 510 on a regular basis in order to maintain or increase storage capacity for new and incoming information to be stored in the new daily grey file 522. For example, information stored in the new daily grey file-522 during the past 24 hours can be transmitted to the second-type module 510 at a predetermined time for storage in a data storage device. The predetermined time is called a “nightly load.” The information in the new daily grey file 522 is deleted or otherwise written over as the new information is collected or received by the grey data enrichment module 508 and stored in the new daily grey file 522 for the next 24 hour time period.

Information stored in the risk database 520 is also transmitted to the second-type module 510 at a predetermined time, such as in a “nightly load”, and subsequently stored by the second-type module 510 in a data storage device such as a grey database (described below as 538). Information in the risk database 520 is deleted or otherwise written over as the new information is collected or received by the grey data enrichment module 508 and stored in the risk database 520.

New information is received by the grey data enrichment module 508 on a daily, periodic, or in some instances, an infrequent basis. The risk database 520 is adapted to store information received by the grey data enrichment module 508 that can be readily matched against existing inquiry requests received by or otherwise stored by the second-type module 510. As explained below, information collected by the system 502 must be compared to existing inquiry requests submitted by customers 512 in order to determine whether a possible match or match exists, so that a customer 512 can be notified of a potential match.

The archive engine 524 processes matching information located by the search engine 518 and stores selected or relevant information in the risk database 520 or new daily grey file 522, or another data storage device. Typically, the archive engine 524 is a set of computer-executable instructions adapted to parse, document, index, and process collected or received matching information from the search engine 518. The same functions of the archive engine 524 can also be manually performed by one or more operators or persons that receive information collected by the search engine 518.

The archive engine 524 determines whether collected or received matching information from the search engine 518 is relevant information. Selected or relevant information is further processed by the archive engine 524 into location information and abstract information. In some instances, the archive engine 524 may process raw information stored by the search engine 518 in the risk database 520 or new daily grey file 522, or another data storage device. Location information is defined as a network address, Internet address, website, webpage, hyperlink, link, or other pointer or location information that is associated with information retrieved or otherwise located by the search engine 518. Abstract information is a combination of a relevant keyword, phrase, or other specific information that is associated with information retrieved or otherwise located by the search engine 518. The archive engine 524 can generate and store location information as a pointer file, and abstract information as an abstract file.

For example, a customer's inquiry request may contain or be associated with one or more keywords, phrases, or name information. Matching information associated with a specific keyword, phrase, or name information from a customer's inquiry request may be received from the search engine 518. Upon determining that matching information is relevant to a customer's inquiry request, the archive engine 524 can parse or break up relevant or selected information into multiple parts depending upon the relative relevancy of the information's content to the keyword, phrase, or name information. The archive engine 524 can catalog relevant information by the keyword or a particularly relevant phrase associated with the keyword. The archive engine 524 can then document the location of a data source 530 such as a third-party source of information or otherwise store an informational link via a network 504 such as the Internet to a third-party website or other location of a data source 530 linked to the network 504. By further example, a pointer file can contain a “hotlink” back to an original article or portion of information located via a network 504. The location information is then stored as a pointer file or record within the risk database 520 or new daily grey file 522.

The archive engine 524 also generates an abstract of relevant information from a portion of the collected or received information utilizing one or more rule-based abstracting methods or techniques, proprietary linguistic specifications, and keyword referencing. For example, the archive engine 524 creates a unique abstract of relevant information from a portion of information that has been previously collected or received from a data source 530, i.e. an abstract of a published article by a particular author. An abstract can contain names, keywords, dates, location information, copyright holder, source of information, and other similar information. The archive engine 524 can then store the unique abstract as an abstract file (not shown) or record associated with a keyword or relevant phrase. This abstract information is then stored as an abstract file or record within the risk database 520 or new daily grey file 522.

The pointer file and abstract file can be indexed by relevant keyword or phrase by the archive engine 524 in the risk database 520 or new daily grey file 522. Subsequent searches on the risk database 520 or new daily grey file 522 can then locate unique records including a pointer file associated with an abstract file when a potential match to an inquiry request contains a particualr keyword, phrase, or name information.

As discussed above, the functions of the archive engine 524 can also be manually performed by one or more operators or users. These operators can also generate a pointer file and abstract by reading each article located by the search engine 518, and then store the pointer file, abstract, and other information in the risk database 520.

Raw or scanned images of documents, articles, or other information collected by the grey data enrichment module 508 via manually, the search engine 518, or the archive engine 524 are stored in an image database such as the ISYS database 526. The image or ISYS database 526 indexes the stored information for later retrieval by the second-type module 510 when a potential match is made to an inquiry request. For example, a unique record stored in the risk database 520 or new daily grey file 522 may contain a link to a stored article in the image or ISYS database 526. When an alert is generated in response to a particular customer's inquiry request, a unique record from the risk database 520 and a stored article from the image or ISYS database 526 can be transmitted to the customer 512.

The filter/isolate engine 528 handles information communicated from the risk database 520 and/or new daily grey file 522 to the second-type module 510. The filter/isolate engine 528 can be a processor-based platform executing one or more name isolation/assignment subroutines to filter the records, to isolate the names within the records, and to determine name-specific characteristics of information in isolated records, i.e. whether a name in a particular record is a first, middle, or last name, or whether a name is a business name or person's name. Typically, information stored in the risk database 520 and the new daily grey file 522 may be accessed by the second-type module 510 on a regular basis. The filter/isolate engine 528 is adapted to process stored information in the risk database 520 and the new daily grey file 522 to reduce the processing workload of the second-type module 510 when analyzing collected information from the grey data enrichment module 508. Furthermore, records filtered from the risk database 520 and the new daily grey file 522 by the filter/isolate engine 528 before transmission to the second-type module 510 may be records or files containing information subject to credit reporting law and regulations. Credit reporting laws and regulations, such as the Fair Credit Reporting Act (FCRA), distinguish between personal and business information, thus each type of corresponding record must be processed accordingly. For example, when records are accessed by or otherwise transmitted from the risk database 520 and/or new daily grey 522 to the second-type module 510 during a nightly load, the filter/isolate engine 528 executes a set of computer-executable instructions adapted to filter the records, isolate name information within the records, and determine name-specific characteristics of the names within isolated records.

The second-type or global information (GRID) module 510 operates in conjunction with the first-type module 506 and the grey data enrichment module 508. The second-type module 510 includes a clean inquiries engine 532, a logging processor 534, an inquiry portfolio database 536, a grey database 538, a new GRID daily grey file 540, a search/match engine 542, a crunch file 544, a table database 546, an alert engine 548, and an alert database 550. The second-type module 510 handles new, standard format inquiry requests from one or more customers 512 such as financial institutions, as well as reformatted inquiry requests processed by and communicated from the first-type module 506. Information collected and stored by the grey data enrichment module 508 is received, accessed, or utilized by the second-type module 510 when processing inquiry requests from one or more customers 512. The second-type module 510 is adapted to receive an inquiry request from a customer 512, to match an inquiry request with potentially relevant information from the grey data enrichment module 508, and to notify the customer 512 when a particular inquiry request matches potentially relevant information.

A customer 512 that desires to submit an inquiry request to the second-type module 510 transmits an inquiry request to the second-type module 510 via a network 504 such as the Internet. For example, a customer 512 such as a financial institution could be opening a new account for a third-party. In association with opening a new account, the customer 512 can enter identifying information into an associated computer in communication with a network 504 such as the Internet. The identifying information can be input into the computer by an operator using a new, standard format inquiry request, such as an electronic form. When all required information is input into the form, the operator can automatically transmit the inquiry request and identifying information to the second-type module 510 for further processing. Alternatively, an inquiry request can be automatically generated by an associated system or client that the customer 512 operates in the course of an ordinary work routine or process.

The clean inquiries engine 532 is adapted to receive, to process, and to store one or more “clean” inquiry requests from a customer 512 such as a financial institution or a brokerage house. Typically, the clean inquiries engine 532 is a processor-based platform that executes a set of computer-executable instructions for handling an inquiry request from a customer 512 via a network 504 such the Internet. A “clean” inquiry request is defined as an inquiry request that is formatted in a new, standard format for processing by the second-type module 510. A format that is ready for processing by the second-type module 510 is a new, standardized format that includes a portion of the following information: social security number, last name, first name, spouse name, account number, address information, or other unique identifying information. Once a “clean” inquiry request is received by the clean inquiries engine 532, the clean inquiries engine 532 can verify that the format of the inquiry request is by analyzing whether certain fields in a received form have been completed by the customer 512. If a certain inquiry request is not “clean”, unverifiable, or otherwise not understood, the customer can be contacted by the second-type module 510 to resubmit sufficient information for a “clean” inquiry request.

In any event, when a “clean” inquiry request is submitted by the customer 512, then the clean inquiries engine 532 executes one or more isolation/assignment subroutines on the inquiry request. The isolation/assignment subroutines are adapted to isolate any name information in the inquiry request, and further adapted to identify whether the name is a first, middle, or last name, or whether the name is a business name or person's name. These isolation/assignment subroutines are needed to determine whether particular inquiry requests contain a person's name or a company or business name. Such information may be subject to credit reporting laws or regulations. Credit reporting laws and regulations, such as the Fair Credit Reporting Act (FCRA), distinguish between personal and business information, thus each type of corresponding record must be processed accordingly. If a particular inquiry request is subject to such laws or regulations, the second-type module 510 can identify the particular inquiry request appropriately and process the inquiry request in a specific manner as described below.

After one or more name isolation/assignment subroutines have been executed on an inquiry request, the clean inquiries engine 532 stores the inquiry request and any isolated name information in the inquiry portfolio database 536 for further processing by the second-type module 510. An isolation/assignment subroutine can include, but is not limited to, a name assignment subroutine, a name isolation subroutine, or any other routine, subroutine, filter, method, process, or set of instructions that can identify a name in an inquiry request, record, or file, and determine whether the name is a business name or a person's name. For example, a name isolation subroutine such as an Isolate Company Versus Person Names filter identifies and isolates the name fields in an inquiry request for processing subsequent filters on the particular record. The Isolate Company Versus Person Names filter also rearranges information into their proper fields if field information appears to be incorrect, jumbled, or otherwise missing. A name assignment subroutine such as a sequence of one or more name assignment filters determines whether a particular name in an inquiry request is a business name or a person's name. The name assignment filter can then identify the file with a marker or a flag as corresponding to a business or person's name.

Executing one or more isolation subroutines on a “clean” inquiry request also reduces the amount of processing time needed by the second-type module 510 to subsequently process an inquiry request and potentially match the inquiry request to relevant information. When there is a relatively high degree of certainty that a name field in an inquiry request contains an actual business or person's name, the second-type module 510 can further access or process the inquiry request with the search/match engine, and obtain greater matching accuracy when the second-type module 510 compares the inquiry request to the appropriate group of previously stored business or person name records and information. Furthermore, certain inquiry requests subject to FCRA regulations or other privacy laws can be readily identified and handled in a specific manner in accordance with applicable regulations or laws.

Generally, when a customer 512 transmits an inquiry request to the first-type module 508 or to the second-type module 510, the customer 512 is a returning system 502 user. In some instances, if the customer 512 has not used or accessed the system 502, the customer 512 is a new system 502 user. In either case, the activities of the new or existing customer 512 must be logged when using the system 502. The logging processor 534 is adapted for authenticating the customer 512, tracking the customer's system usage and customer identification information, and creating a billing record for a customer's transactions with the system 502. The logging processor 534 is typically a set of computer-executable instructions adapted to implement a log-in procedure for new and current customers. Any conventional authentication or log-in procedure and/or method can be used to authenticate a customer 512. After the customer 512 is authenticated by the logging processor 534, the logging processor 534 tracks the customer's system usage. The customer's identification information can be associated with inquiry request submitted to the system 502 as well with records and information that may matched to a particular inquiry request. Furthermore, the logging processor 534 can create a billing record that documents each transaction that the customer 512 makes with the system 502, and tracks and/or stores the customer's particular usage of the system 502 and services for future reference or billing purposes.

For example, when a customer 512, such as a first time system user, submits an clean inquiry request to the second-type module 510, the logging processor 534 sets up a new account with identifying information received from the customer 512. The logging processor 534 can then match the customer 512 with a list of approved customers, and stores the customer's identifying information for future authentication and subsequent access to the system 502. After the customer 512 is authenticated, the logging processor 534 tracks each transaction with the customer 512 and stores usage information as well as associates inquiry requests and relevant matching records with the customer 512 for later analysis such as billing determination.

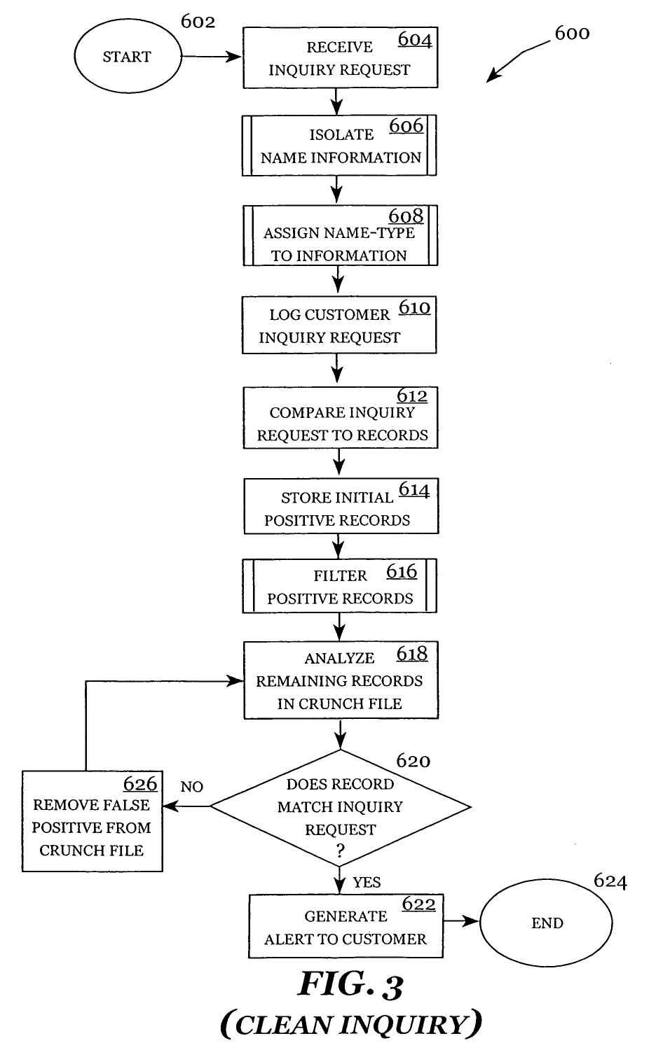

All inquiry requests transmitted to the GRID module 510 are stored in the inquiry portfolio database 536 for later retrieval. Each inquiry request is stored as an individual record in a unique portfolio corresponding to a customer's record or file stored in the inquiry portfolio database 536. These records and associated portfolios can be searched and accessed later by the search/match engine 542 for comparison to files, records, or information stored in the grey database 538, new GRID daily grey file 540, or in any other accessible database or data storage device. Each record for an inquiry request can also include one or more watch list items, and an update request. An exemplary method for processing a new inquiry request is shown and described with respect to FIG. 3.

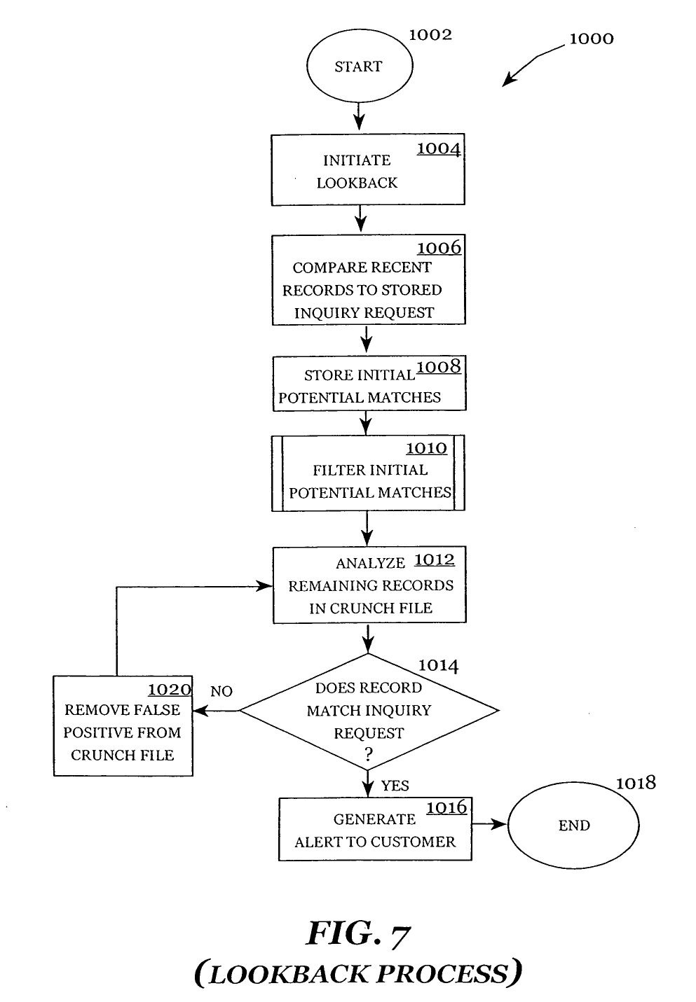

The inquiry portfolio database 536 also tracks previously submitted inquiry requests that have already been searched and/or matched by the second-type module 510. These types of inquiry requests are processed in a method such as a “lookback” or a “watch list” process. An exemplary method for processing previously submitted inquiry requests is shown and described with respect to FIG. 7. In a “lookback” process, when a customer has previously submitted inquiry request, the inquiry request is stored in an associated customer portfolio in the inquiry portfolio database 536. On a predetermined basis, the search/match engine 542 can attempt to match the inquiry request against recent record or file entries stored in the new GRID daily grey file 540 to see if a potential match for relevant information exists. In most instances, depending upon the recency of the information and the customer's predetermined basis, the grey database 538 does not have to be searched in order to update the potential matches for a particular inquiry request.

Furthermore, in a “watch list” process, a customer may submit one or more watch list items to the second-type module 510 as an inquiry request. A watch list item can include one or more names or other pieces of information that a customer wants to constantly monitor and be notified if a potential match, direct match, or a change in status information associated with the name or piece of information occurs. The watch list items are stored in the inquiry portfolio database 536, and the search/match engine 542 monitors the new GRID daily grey file 540 for recent record or file entries stored in the new GRID daily grey file 540 to see if a potential match for relevant information exists. As a further aspect of a “watch list” process, a customer may submit an update request as part of an inquiry request to the second-type module 510. An update request is a request by the customer to respond immediately, on a continuing or ongoing basis, or on a periodic basis with information regarding a watch list item or a particular name. A particular update request for an inquiry request may also depend upon a customer's need for information regarding a particular inquiry request. The second-type module 510 stores the update request as part of the customer's portfolio stored in the inquiry portfolio database 536. The search/match engine 542 monitors the new GRID daily grey file 540 in accordance with the customer's update request, for recent record or file entries stored in the new GRID daily grey file 540 to see if a potential match for relevant information exists. The search/match engine 542 generates update information that corresponds to the update request and includes any new information that the search/match engine 542 locates in response to the customer's update request.

Note that subroutines, filters, and methods to facilitate a “lookback” process and a “watch list” process are similar to those described and associated with the search/match engine 542 below.

The grey database 538 is adapted to receive and store information transmitted from the grey data enrichment module 508 via the isolate/filter engine 528. Typically, this information has been filtered or otherwise screened by the isolate/filter engine 528, and the information transmitted to the second-type module 510 is information that is not regulated by the FCRA or another applicable privacy law. The information stored in the grey database 538 can include public information, private information, location information, pointer files, abstract files, articles, abstracts, or other information gathered by the grey data enrichment module 508 and stored in the risk database 520. During a nightly load, the new filtered information is communicated from the grey data enrichment module 508 via the isolate/filter engine 528 to the second-type module 510 and stored in the grey database 538. As additional information is collected by the grey data enrichment module 508 and transmitted to the grey database 538, the information stored by the grey database 538 is continuously stored for later use by the second-type module 510 until called upon by the search/match engine 542.

The new GRID daily grey file 540 is adapted to receive and store information transmitted from the new daily grey file via the isolate/filter engine 528. The updated information in the new GRID daily grey file 540 can then be called upon by the search/match engine 542 for potential matching to an inquiry request. Typically, new information is collected or received on a daily basis and stored by the grey data enrichment module 508 in the new daily grey file 522. This new information is filtered by the isolate/filter engine 528, updated to the new GRID daily grey file 540 in a “nightly load”. As additional new information is collected or received by the grey data enrichment module 508 and transmitted to the new GRID daily grey file 540, the information stored in the new GRID daily grey file 540 is continuously updated for later use.

After an inquiry request has been stored by the inquiry portfolio database 536, the second-type module 510 attempts to one or more match inquiry requests with information collected or received by the grey data enrichment module 508. The search/match engine 542 implements one or more methods, routines, or subroutines for searching collected or received information, and matching an inquiry request to the collected or received information. The search/match engine 542 is a processor-based platform adapted for executing a set of computer-executable instructions to initially search collected or received information for one or more potential matches to an inquiry request.

Typically, the search/match engine 542 searches information stored in the portfolio inquiry database 536, the grey database 538, and the new GRID daily grey file 540 or any other database or data storage device accessible by the search/match engine 542. Various search methods, routines, or subroutines can be utilized by the search/match engine 542 to locate specific information in each of these structures by keyword, relevant phrase, or a combination thereof.

Furthermore, the search/match engine 542 can filter an initial search list to reduce the match possibilities to one or more potential matches from records in the grey database 538, the new GRID daily grey file 540 or any other database or data storage device accessible by the search/match engine 542. Various filtering methods, routines, or subroutines can be utilized by the search/match engine 542 to filter an initial search list to reduce the match possibilities to one or more potential matches.

For example, when the search/match engine 542 performs an initial search for a customer's inquiry request, the search/match engine 542 generates a list of possible matches with names that are similar or otherwise close to the customer's inquiry request. The list of possible matches can include a set of candidates, possible false positive matches, and possible positive matches to the customer's inquiry request. This list of possible matches can then be stored in a crunch file 544 or another data storage device for further access, processing, and/or filtering. One or more “match” methods, routines, subroutines or filters can be executed by the search/match engine 542 to further reduce or qualify the list of possible matches, and then generate a ranking or sequential order for the reduced or qualified list of potential matches depending upon the quality, quantitative value, or confidence level of the potential match. The search/match engine 542 is further adapted to access a table database 546 as needed to compare previously verified or otherwise known information with information contained in an inquiry request, grey database 538, new GRID daily grey file 540, or any other database or data storage device. Finally, the search/match engine 542 is adapted to generate a reduced crunch report including the reduced or qualified list of potential matches, with each potential match assigned a corresponding score depending upon a score, quality, or confidence level of the respective potential match.

As disclosed above, the crunch file 544 stores a list of possible matches generated by the search/match engine 542 from an initial search. Typically, the crunch file 544 communicates with the search/match engine 542 to receive a list of records or files. The crunch file 544 is further adapted to receive a list of potential matches from the search/match engine 542 that include a set of candidates, possible false positive matches, and possible matches to an original inquiry request. One more methods, routines, subroutines or filters can be utilized by the search/match engine 542 to remove records or files from the list stored in the crunch file 544 that are not “true” matches and remove any records or files from the list that cannot be used to alert a customer 512. The search/match engine 542 can reduce the total number of records or files that must be evaluated by the alert engine 548, thus reducing the amount of processing time needed for the alert engine 548 to manually or automatically review the final crunch file 544. Methods, routines, subroutines or filters that can be executed by the search/match engine 542 include, but are not limited to, Name/Gender, Social/State/Region, Firm File Account Recency, Company Code Matching, Problem Code, Duplicate Record, FCRA Cannot Be Alerted, Employment Matching, No Longer Employed, and FCRA Data Firms Out of Business.

As disclosed above, the table database 546 can be accessed by the search/match engine 542 when needed. A table database 546 is adapted to store one or more supporting tables containing previously selected, verified or otherwise known information. When the search/match engine 542 utilizes one or more methods, routines, subroutines or filters to process a list of records or files in the crunch file 544, the search/match engine 542 may access the table database 546 to check or verify information from a record or file with previously verified or otherwise known information contained in one or more tables of the table database 546. Similar to the information contained in supporting tables described above in 414, previously selected, verified or otherwise known information that can be stored in a supporting table can include, but is not limited to, business words, business phrases, foreign business words, name attributes, and social/state ranges, zip codes, social security numbers, area codes, geographic codes for country names, and other information that may be publicly or privately available. Furthermore, the table database 546 is adapted to receive updated supporting tables via another database or data source 530 via a network 504, a third-party data source or from another remote data source as needed.

After the search/match engine 542 has generated a list of potential matches for an inquiry request, and generated a report including the reduced or qualified list of potential matches, the alert engine 548 receives the report and analyzes records or files associated with the report. The alert engine 548 is adapted to receive a report including one or more records or files from the crunch file 544. Moreover, the alert engine 548 is adapted to analyze the records or files from the crunch file 544, and further adapted to generate an alert if a particular record or file is determined to be a match to the customer's inquiry request.

The alert engine 548 can be a processor-based platform adapted to execute a set of computer-executable instructions for analyzing records or files in the crunch file 544, and to compare the records or files to an inquiry request. The alert engine 548 automates the generation of alerts to customers 512, analysis of the crunch file 544, and the subsequent transmission or communication of alerts to customers 512. Furthermore, the alert engine 548 is adapted to communicate with an alert database 550 for storage of alerts transmitted to or otherwise communicated to customers. An example of a system and method associated with an alert engine in accordance with various embodiments of the invention, is described with respect to FIGS. 10-11.

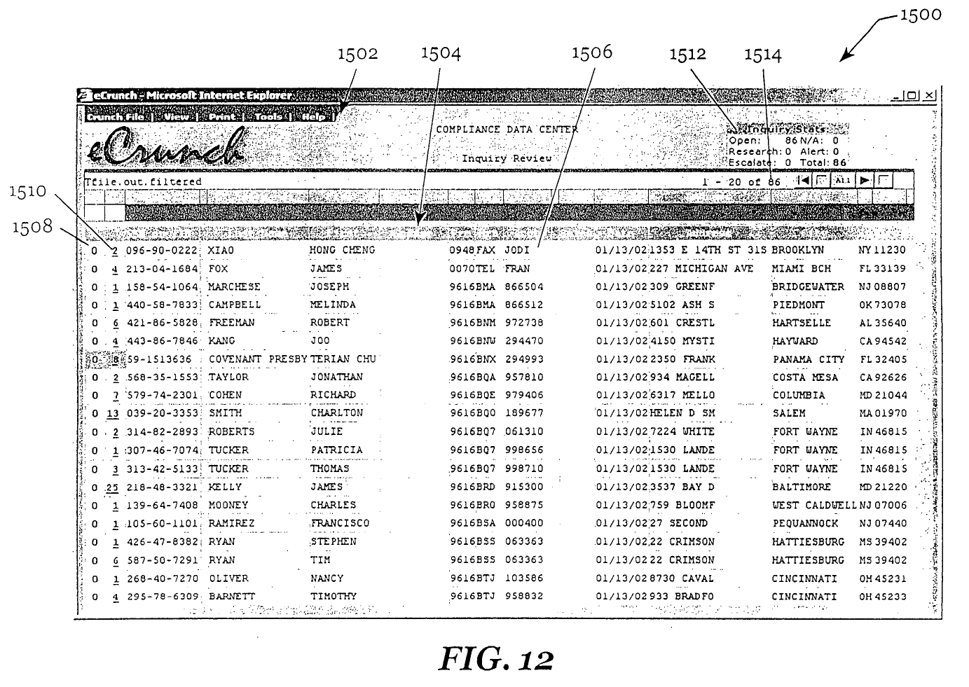

The alert engine 548 is also adapted to provide a user interface such as a visual display for operator control of methods, routines, subroutines or filters applied to the crunch file 544. An associated display system (not shown) can permit a system operator or user to enter a query to a search subroutine which pulls information from one or more databases that match the operator or user's query. An example of a user interface associated with a system and method in accordance with various embodiments of the invention, is described with respect to FIGS. 12-16.

The alert engine 548 reviews the list or set of records or files in the crunch file 544 that have initially been matched to an inquiry request. Each record or file on the list in the crunch file 544 is called a “candidate”. The alert engine 548 then determines whether each candidate contains sufficient information to match an inquiry request, i.e. a “positive” match; whether a candidate definitely does not match an inquiry match, i.e. a “negative” or “false positive” match; or whether a candidate contains information that could positively match an inquiry request, but still contains negative information.

For a “positive” match, the alert engine 548 transmits an alert to the customer 512 initiating the particular inquiry request. The alert includes the candidate and any associated information matching the inquiry request to the customer 512. A record of the alert is then stored in the alert database 550 by the alert engine 548.

For a “negative” match, the alert engine 548 removes the candidate from the list of records or files in the alert database 550. Candidates removed from the list in the crunch file are negative or “false positive” matches, and must be eliminated from the list of records or files in the crunch file 544.

For a candidate that contains information that could positively match an inquiry request, but still contains negative information, the alert engine 548 has determined that the particular candidate may still be relevant enough to positively match the inquiry request, but cannot determine whether the customer 512 should be notified of the particular candidate. In this instance, the alert engine 548 performs additional research for the particular candidate. The alert engine 548 can utilize information or data from other databases or third-party data sources to perform additional research on the candidate. Should the alert engine 548 determine that there is sufficient information to make a “positive” match, the alert engine 548 transmits an alert to the customer 512 initiating the inquiry request. The alert includes the candidate and any associated information matching the inquiry request to the customer 512. A record of the alert is then stored in the alert database 550 by the alert engine 548.

If the alert engine 548 determines that there is negative information for the candidate, the alert engine 548 does not alert the customer 512, and the candidate is removed from the list of records and files in the crunch file 544.

Note that the above functions of the alert engine 548 can also be manually performed by one or more operators such as “alerters” that manually review one or more inquiry requests.

If an alert is generated by the alert engine 548 or by an alerter, a message is communicated to the customer 512 initiating the particular inquiry request by communication means such as e-mail, telephone call or message, facsimile, physical mail, electronic copies of files transmitted via a network 504 with a file transfer protocol, or via a web portal accessible from a network 504 such as the Internet. The alert can include the inquiry request, messages or files with XML content, scanned hard copies of one or more records or files, or any other information associated with a candidate that is a “positive” match with the inquiry request.

An alert database 550 stores a copy of any alert, message communicated to a customer 512 by the alert engine 548 or alerter, or any other information sent to a customer 512 in response to an inquiry request. Information stored in the alert database 550 can include, but is not limited to, historical data, alert-specific characteristics such as personnel that analyzed a particular inquiry request, and reasons for generating an alert to the customer 512.

In another system in accordance with various embodiments of the invention, a system can incorporate the functionality of the grey data enrichment module 508 and second-type module 510 and perform the functions described above. This system embodiment may be implemented with a network 504 operating in a remote location such as another country. Associated methods, routines, subroutines and filters described in FIGS. 3-9 can be implemented with either the system 502 described in FIG. 2 or other system embodiments.

FIG. 3 is a flowchart for a method 600 in accordance with various embodiments of the invention. The method 600 is adapted to determine a potential match of search information in response to a new inquiry request from a customer. Typically, the method is a set of computer-executable instructions that can be implemented by the system 502 or by a combination of modules 506-510 described above. Prior inquiry requests transmitted to the second-type module 510 can be handled by another method, shown and described in FIG. 7.

Method 600 begins at 602.

602 is followed by 604, in which the system 502 receives an inquiry request. As previously described above, an inquiry request can be a request received from a customer 512 via a network 504 for information regarding a third-party. Typically, the clean inquiries engine 532 receives an inquiry request that is a “clean” inquiry request as previously defined, wherein the inquiry request contains a request for information from the customer 512 or has otherwise been “cleansed” by a first-type module 506 or another module, method, or process.

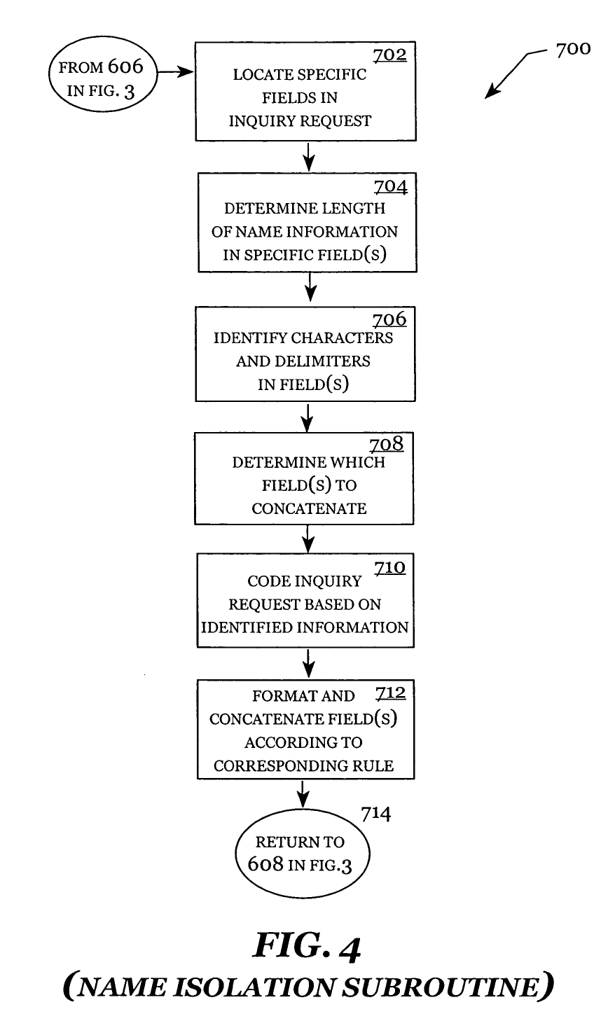

604 is followed by subroutine 606, in which name information is isolated (and assigned) in the inquiry request. Generally, the clean inquiries engine 532 utilizes a name isolation subroutine to determine and identify name information in one or more fields of an inquiry request. Determining and identifying name information in one or more fields reduces the amount of information that needs to be processed, and permits each record to be identified in a relatively quicker manner. An exemplary subroutine for isolating name information in an inquiry request is illustrated and described below with respect to FIG. 4.

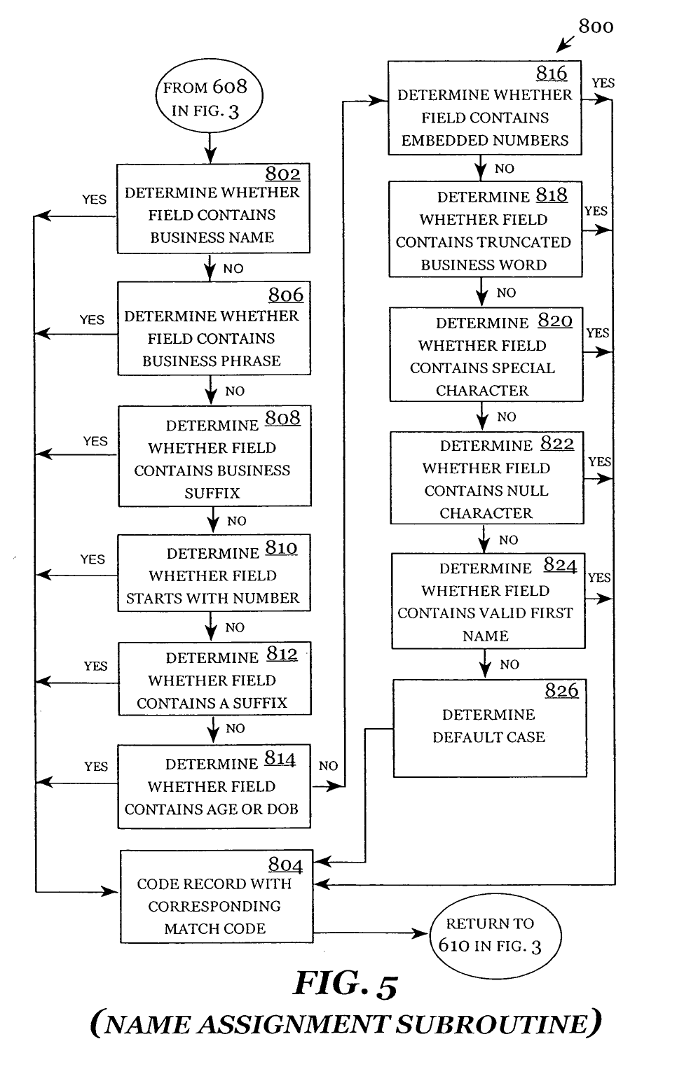

606 is followed by subroutine 608, in which an inquiry request is designated as a person-type record or a business-type record. Generally, the clean inquiries engine 532 utilizes a name assignment subroutine to determine whether a particular inquiry request is associated with a name of a person or a name of a business or organization. Depending upon the determination, the name assignment subroutine determines whether the particular inquiry request is associated with a person's name or company name, and thus subject to the Fair Credit Reporting Act (FCRA) or other applicable credit reporting law and regulations. In any event, the clean inquiries engine 532 denotes the type of inquiry request and stores the customer's inquiry request as a file or record in the inquiry portfolio database 536. An exemplary subroutine for determining the type of inquiry request and assigning the inquiry request as a person or business-type record is illustrated and described below with respect to FIG. 5.

608 is followed by 610, in which the customer's inquiry request is logged. When a customer 512 submits an inquiry request, the logging processor 534 logs the customer's transactional and billing activity for usage of the system 502. Moreover, new or existing customers can be authenticated by the logging processor 534. Typically, a new inquiry request from an existing customer is processed by the second-type module 510 in a similar manner to a new inquiry request from a new customer.

610 is followed by 612, in which an inquiry request is compared to a stored record. The search/match engine 542 compares the inquiry request to records stored in the grey database 538, new GRID daily grey file 540, or another data storage device. Typically, the search/match engine 542 utilizes one or more keyword or relevant phrases from an inquiry request to search records or files for matching or similar keyword or relevant phrases in a stored record or file.

For example, an incoming inquiry request may have a social security number. The social security number of the inquiry request is compared to social security numbers associated with one or more records in the grey database 538. Other information or fields within an inquiry request can also be compared including, but not limited to, first name, last name, and business name. Conventional search and matching methods, routines, subroutines, and techniques can also be utilized by the search/match engine 542.

For inquiry requests identified as associated with a person's name, a predetermined number of bytes or characters of the first name and the last name can be compared to corresponding bytes or characters in a first name and last name of records in the grey database 538 previously identified as associated with a person's name. If a first name or last name is greater than another predetermined number of bytes, a first initial can be used for comparison to records in the grey database 538. Alternatively, for inquiry requests associated with a business name, yet another predetermined number of bytes or characters of the business name can be compared to corresponding bytes or characters in business names of records in the grey database 538 previously identifies as associated with a business name.

612 is followed by 614, in which initial positive matches are stored. When an initial match is made between an inquiry request and a stored record or file, the search/match engine 542 stores a corresponding record or file in the crunch file 544 as an initial positive match. For example, if an incoming inquiry request has a social security number that matches a social security number associated with a record in the grey database 538, then the particular record is copied to the crunch file 544 as a hard “hit”. In another example, if a predetermined number of bytes or characters of a last name and first name for an inquiry request match corresponding bytes or characters of a last name and first name of one or more records associated with a person's name in the grey database 538, these records are copied to the crunch file as “candidates”. For an inquiry request associated with a business name, if a predetermined number of bytes or characters of the business or company name match corresponding bytes or characters of a business or company name of one or more records associated with a business name in the grey database 538, these records are copied to the crunch file 544 as “candidates”. “Candidates” and hard “hits” are both initial positive matches that must be further processed by the second-type module 510 to verify and further characterize the “match”. All records or files from the grey database 538 that contain initial positive matches are stored in the crunch file 544 by the search/match engine 542 and further processed by the second-type module 510 to filter false positives from the final records in the crunch file 544.

614 is followed by subroutine 616, in which a subroutine filters the initial positive matches. The search/match engine 542 applies one or more methods, routines, subroutines or filters to the initial positive matches in the crunch file 544 to filter out false positives and to reduce the size of the crunch file 544. The remaining records or files are continuously stored by the crunch file 544 as potential positive matches. The methods, routines, subroutines or filters used to determine the initial positive matches can be selected by a user or operator. For example, a user may be provided with options via an associated display screen (not shown) to display a list of all filters that can be applied to the crunch file. The user may have the option to select or enable particular filters to be applied, and to remove or disable particular filters as desired. The ability to enable or disable particular filters applied to the crunch file provides the user with capabilities to test filters, validate filters, and/or adjust the confidence or certainty level for initial positive matches.

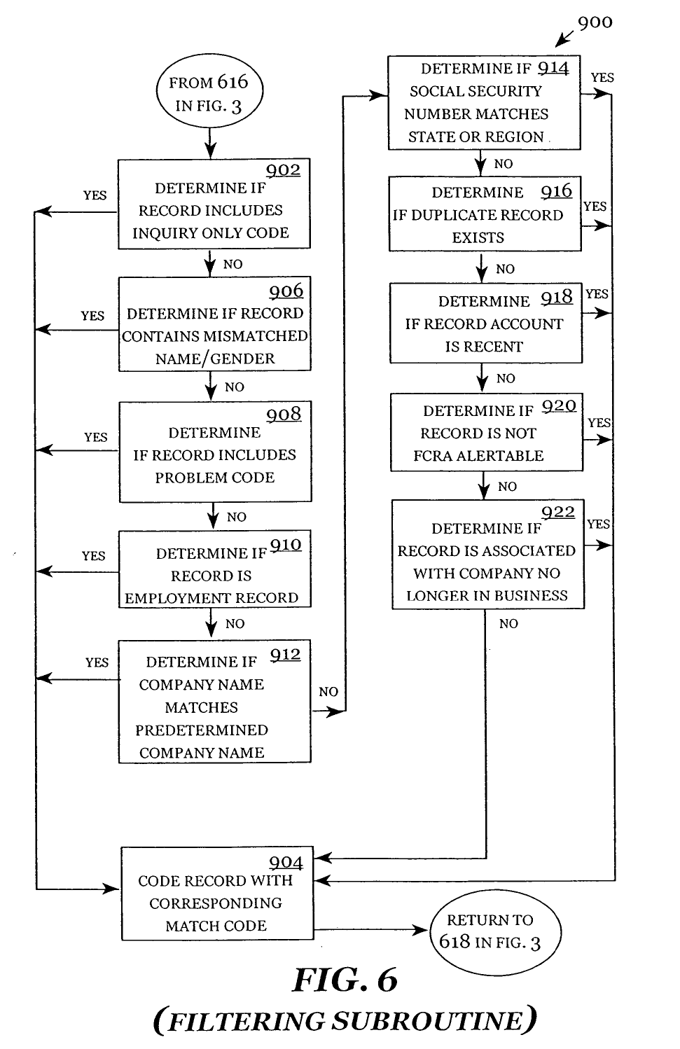

Furthermore, records or files that cannot be used to alert a customer 512, such as records that may be subject to applicable credit reporting laws or regulations, are also filtered out to further reduce the size of the crunch file 544. For example, an exemplary subroutine for filtering a crunch file is illustrated and described below with respect to FIG. 6. The subroutine 614 implements a series of filters or subroutines designed to process records and identify specific information that may disqualify or otherwise qualify the record in response to an inquiry request. Some filters are designed to process records associated with a person's name. Other filters are designed to process records associated with a business or company name. Yet other filters are designed to process all types of records. Examples of various filters that can be utilized by a subroutine for filtering a crunch file are also described below with respect to FIG. 6.

Typically, when a particular record is identified by a particular filter as a potential “positive match” or otherwise excluded by the filter as a “false positive” or other designation, the record is coded with a code corresponding to the filter that identified or excluded the record. The code can be utilized later for an analysis of the relative effectiveness of the filters or records. For example, as shown in FIGS. 12-16, a user such as an alerter may review a webpage displaying multiple records that have been positively matched to an inquiry request as well as records that have been identified or flagged by a filter.

The subroutine 616 via the search/match engine 542 can utilize a table database 546 or other data storage device to obtain one or more lists of predetermined information to compare either a customer's inquiry request or collected information to known information. The search/match engine 542 tends to be relatively lenient during the “search” phase to generate a list of possible matches containing one or more “false positive” matches, i.e. records that under manual review are not “positive matches”, and “positive matches” that under manual review are relevant to the inquiry request. Typically, most “false positive” matches are filtered out by the subroutine 616, and the remaining records or files in the crunch file 544 can be further reviewed or otherwise filtered.

616 is followed by 618, in which the remaining crunch file is analyzed to determine final positive matches. Any remaining records or files, i.e. “potential positive” matches, in the crunch file 544 are reviewed or otherwise filtered by the alert engine 548 or an alerter. If additional information is necessary for a particular record or file in the crunch file 544 to determine whether a final positive match is made to an inquiry request, then additional research can be performed on the record or file, or otherwise requested before a determination is made for the particular file or record.

For example, an alerter can use associated systems and methods shown in FIGS. 10-11, such as an “eCrunch” system and “BizFlow” method. Associated systems and methods can access records from the inquiry portfolio database 536, the grey database 538, and the alert database 550. Data from the image or ISYS database 526, such as scanned images, may also be accessed via the associated systems and methods or via a network 504 or Internet-based system. Using associated systems and methods, the alerter can research records and information from any combination of these data sources in order to assist in a determination about a particular potential positive match file or record. The associated systems and methods are further illustrated and described in FIGS. 10-11.

618 is followed by decision block 620, in which a determination whether a particular record in the remaining crunch file matches an inquiry request. Typically, associated systems and methods shown and described in FIGS. 10-11, permit the alert engine 548 or alerter to determine whether a record or file remaining in the crunch file 544 is a “final” positive match to a customer's inquiry request. If a “final positive” match is made, then the “YES” branch is followed to 622.

In 622, the customer is alerted to the “final positive” match. Typically, the alert engine 548 or alerter generates an alert in response to determining a “final positive” match to an inquiry request. The alert engine 548 transmits the alert to the customer 512 to notify the customer 512 of a “final positive” matching record or file in response to the customer's inquiry request. An alert to a customer 512 can include a message with an abstract of relevant information associated with the record or file causing the positive match, and location information such as a link to an article associated with the abstract. Data from the image or ISYS database 526 can also be transmitted to the customer 512, such as a file containing a scanned image of the article. After the alert engine 548 or alerter transmits an alert to the customer 512, a record of the alert can be stored in the alert database 550 for later reference.

Note that multiple entities can be alerted by the alert engine 548 or alerter. In some instances, a customer may be precluded from sharing information among multiple entities related to the customer. For example, at least one statute prohibits sharing of information between related entities of a single company when the related entities are doing business in banking and insurance respectively. In response to determining a “final positive” match to an inquiry request, the alert engine 548 or alerter can communicate a respective alert to each entity in order to avoid violating applicable statutes or regulations. Therefore, even if multiple entities of a single customer submit inquiry requests for different or similar information, respective alerts can be generated or otherwise communicated to each entity when positive matching information is determined for each entity's respective inquiry request.

After 622, the method 600 ends at 624.

Referring back to decision block 620, if a particular record does not match the inquiry request, i.e. a record is determined to be a “false positive”, then the “NO” branch is followed to 626. In 626, the false positive record is filtered from the crunch file. Typically, the alert engine 548 or alerter removes the false positive record or file from the crunch file 544, and no alert is generated for the particular record or file.

After 626, the subroutine 600 returns to 618, in which any remaining records or files in the crunch file 544 are analyzed to determine any “final positive” matches with the inquiry request.

Typically, the method 600 continues as described above until the crunch file 544 is exhausted, and a customer 512 is either alerted or not alerted with respect to the inquiry request.

FIG. 4 is a flowchart of a subroutine of the method shown in FIG. 3. The subroutine 700 is adapted to isolate a name in an inquiry request or record. The subroutine 700 can also be used to identify records or inquiry requests in which an error exists, so that these records or inquiry requests can be repaired or otherwise corrected prior to subsequent processing. The subroutine 700 begins at 702.

In 702, specific fields in an inquiry request or record are identified. Typically, an inquiry request or record will be a standardized, clean inquiry request transmitted to the second-type module 510. In other instances, the inquiry request or record may be a reformatted conventional or first-type inquiry request transmitted from the first-type module 506. In another instance, a record may be an abstract or other data collected or otherwise received by the system 100 such from the grey data enrichment module 508. In any event, the “clean” inquiry request or record contains one or more fields containing relevant identifying information about a person or a business that a customer 512 is interested in tracking or otherwise receiving information about. The clean inquiries engine 532 identifies specific portions of the inquiry request such as one or more predetermined fields for receiving name information. Since one or more fields may exist in a particular inquiry request, i.e. concatenated primary name, last name, first name, spouse name, and address, initially identifying the name field permits the second-type module 510 to efficiently process inquiry requests.

702 is followed by 704, in which the length of information in a particular identified field is determined. Based on the length of name information in one or more particular fields, a particular set of processing rules can be applied to the inquiry request. For example, . . . . Conventional information processing techniques can be applied to determine the number of characters in a particular field.

704 is followed by 706, in which characters and delimiters in particular fields are identified. Within each of the fields determined to contain relevant name information, specific characters or delimiters may exist in these fields, thus creating exceptions to handling the name information contained in the fields. After characters from a particular field are concatenated in 706, the characters can then be processed to identify particular characters, delimiters, or combinations thereof. For example, some characters, delimiters, or combinations thereof may be associated with commonly recognized person-type or business-type information, i.e. “doing_business_as” or “care_of.” Conventional techniques can be used to identify characters and delimiters in particular fields.

706 is followed by 708, in which a determination is made to concatenate particular fields. For example, if in 704 a first name field is determined to contain 9 or 10 bytes, and the first byte of a spouse field is not blank, then an assumption can be made that the last name, first name, and spouse fields contain relevant name information, and these particular fields can later be concatenated. If in 704, a determination is made that the first name field contains less than 9 bytes, then an assumption can be that the last name and first name fields contain relevant name information, and these particular fields can later be concatenated. Conventional information processing techniques can be applied to concatenate the characters in a particular field.

708 is followed by 710, in which the inquiry request is coded with one or more identifiers. Depending upon the content of the particular fields, an inquiry request can be coded with one or more identifier that indicates the existence of name-type information, such as a person or a business. Particular identifiers associated with an inquiry request can subsequently be used to code the inquiry request as either a person-type or business-type record. For example, codes such as DBA and CO, can correspond respectively to delimiters such as “doing_business_as” and “care_of.”

Note that observations from the prior processing of records can be tabulated into a series of tables for the coding of subsequent records or inquiry requests. For example, a table that identifies a particular field type, the location of particular information within a field, the type of information, and a unique identifier code for the information can be used to code the record or inquiry request. Particular field types can include, but are not limited to, first name field only; spouse name field only; both the first name and spouse name fields; all three of the last name, first name, and spouse name fields; and the last name field only. Location of particular information within a field can include, but is not limited to, first word only, embedded word, both a first word and embedded word, words with a leading or trailing space or non-numeric/alphabetic character, words with a leading and trailing space or non-numeric/alphabetic character, word with only a leading space or non-numeric/alphabetic character, word with only a trailing space or non-numeric/alphabetic character. Type of information can include, but is not limited to, designations that indicate a name-type information. Finally, unique identifier code can include, but are not limited to, codes associated with name-type information and that can be further associated with an inquiry request or record.

710 is followed by 712, in which name information is formatted and concatenated in accordance with a rule. Typically, a formatted, concatenated name designates the inquiry request as an output file from the isolation subroutine 700. Using known concatenation techniques, particular fields that are identified as containing name information are concatenated into a string of characters. The resulting string of characters is formatted so that the concatenated string of name information can be output with the file indicating that it has been processed by the isolation subroutine 700.

One or more rules to format and/or concatenate the name information from particular fields can be used and tabulated. Observations from the prior processing of records can be tabulated into a series of rules for the formatting and concatenation of subsequent records or inquiry requests. For example, a table that identifies a particular field type, the location of particular information within a field, the type of information, and a unique identifier code for the information can be used to code the information.

After 712, the subroutine 700 returns to 608 in FIG. 3.

FIG. 5 is a flowchart of a sequence of assignment filters for the method shown in FIG. 3. The sequence 800 or subroutine is a sequence of assignment filters that can determine whether an inquiry request contains a person's name or a business name. The sequence can then code each inquiry request appropriately so that the search/match engine 542 can readily compare particular files from the crunch file 544 without the need for extensive processing by the alert engine 548 or manual analysis of each record in the crunch file 544. Furthermore, each inquiry request in the inquiry portfolio database should be assigned as either a person's name or a business name in order to process or otherwise handle such information in accordance with applicable credit reporting laws and regulations. This distinction is important since certain credit reporting laws and regulations allows for reporting on business entities but not persons. Furthermore, it is important to distinguish between these records since there are some filters that can only be used on person records and other filters that can only be used on business records. When an individual assignment filter identifies an inquiry request associated with either a person's name or with a business name, the assignment filter codes a particular inquiry request, the assignment filter that identified the particular inquiry request is associated with the inquiry request via a code. The relevancy or priority of each assignment filter can then be tracked by the codes, and the order of a sequence of assignment filters can be reassigned or otherwise changed accordingly.

The Person/Company filter determines whether a particular name in a record is either a person's name or a company name. Typically, one or more tables are used to compare a name to. The tables can includes lists of business words, business word abbreviations, business entity designations or abbreviations, and foreign words or abbreviations. The Person/Company name filter can identify at least four types of records: a Person Name, Person Record (PNPR), in which the record has a person's name and is a person's record; Person Name, Business Record (PNBR), in which the record has a person's name but is a business record; Business Name, Business Record (BNBR), in which the record has a business name and is a business record; and Business Name, Person Record (BNPR), in which the record has a business name but is a person's record.

The sequence 800 or subroutine begins at 802, in which a determination is made whether an inquiry request is associated with a business name. Typically, the clean inquiries engine 532 determines whether the “last name field” or the concatenated name field of a particular inquiry request contains a business name. This assignment filter utilizes field matching and concatenated word matching. For example, a comparison between the text in the field and one or more business names contained in a table of business names determines whether the field contains a business name.

One or more tables from the table database 546 may be accessed by the clean inquiries engine 532. For example, a table of business names called the “Business Phrase Table” contains many current, valid business names that have been previously collected and stored. For example, a portion of business names that may be used in a “Business Phrase Table” and that have been previously collected are included in a United States Postal Service Publication, as well as pluralized versions of the business names and phrases contained therein. The “Business Phrase Table” may also include a “Foreign Business Term Table” containing common business words in Spanish, Dutch, French, German, Italian, or any other foreign language. The entire table and its contents may be stored as part of the table database 546, or any other database or storage device associated with the first-type module 506, grey data enrichment module 508, second-type module 510, or otherwise accessible by the system 502.

In some instances, a business name can also be a person's name. Checking the “last name” field of an inquiry request distinguishes whether the inquiry request is associated with a person's name or a business name, i.e. the business name “Smith Barney” will not have a last name associated with the business name, whereas the person's name “Smith Barney” will have a last name associated with the person's name.

When a match is found for a business name in the table, the “YES” branch is followed to 804.

In 804, the clean inquiries engine 532 codes the inquiry request with an appropriate match code that identifies the assignment filter that identified the inquiry request as associated with either a person's name or a business name. An inquiry request with a particular match code can be readily identified as associated with a person's name or a business name. Furthermore, the inquiry request can be coded with a designation such as the following: a Person Name, Person Record (PNPR), in which the record has a person's name and is a person's record; Person Name, Business Record (PNBR), in which the record has a person's name but is a business record; Business Name, Business Record (BNBR), in which the record has a business name and is a business record; and Business Name, Person Record (BNPR), in which the record has a business name but is a person's record.

After 804, the sequence 800 or subroutine returns to 608 in FIG. 3.

If no match is found for a phrase in the table, then the “NO” branch is followed to 806. In 806, a determination is made whether a particular inquiry request is associated with a business-related phrase. Typically, the clean inquiries engine 532 determines whether the inquiry request has any field that has concatenated text containing a business-related phrase. A comparison between the text in the field and business phrases contained in a table of business-related phrases determines whether the field contains a business name. One or more tables from the table database 546 may be accessed by the clean inquiries engine 532. For example, a table of business-related phrases associated with a “Business Phrase Table” contains phrases that are portions of current, valid business names that have been previously collected and stored. Note that each business-related phrase may be matched to business names in the Business Phrase Table so that variations of each portion of a business name may be located. By further example, the portion of a business name such as “Investment Corporation” can be matched to the business-related phrases “Invstmt Corp” and “Investment Corp” in the Business Phrase Table.

When a match is found for a business-related phrase in the table, the “YES” branch is followed to 804 as described above.

If no match is found for a phrase in the table, then the “NO” branch is followed to 808. In 808, a determination is made whether a particular inquiry request includes a field that contains a business-related suffix. Typically, the clean inquiries engine 532 determines whether a particular inquiry request includes any field that has concatenated text containing a business-related suffix. A comparison between the last word in the text in the field and one or more business-related suffixes contained in a table of business-related suffixes determines whether the field contains a business name. A table of business-related suffixes associated with the previously described “Business Phrase Table” includes business-related suffixes that are suffixes of current, valid business-related names that have been previously collected and stored. Note that each business-related suffix may be matched to one or more business-related names in the Business Phrase Table so that suffixes of a business name may be located. For example, the portion of a business name such as “Investment LLC” can be matched to the business-related suffix “LLC” in the Business Phrase Table.

When a match is found for a business-related suffix in the table, the “YES” branch is followed to 804 as described above.

If no match is found for a business-related suffix in the table, then the “NO” branch is followed to 810.

In 810, a determination is made whether a particular inquiry request includes a field that starts with a number. Typically, the clean inquiries engine 532 determines whether the “last name” field in a particular inquiry request starts with a number.

When the last name field is determined to begin with a number, the “YES” branch is followed to 804. In 804, the clean inquiries engine 532 codes the inquiry request with an appropriate match code that identifies the assignment filter that identified the inquiry request as having a last name field beginning with a number. An inquiry request with this match code can be readily identified to be associated with a business name.

If the last name field of a particular inquiry request does not begin with a number, then the “NO” branch is followed to 812.

In 812, a determination is made whether a particular inquiry request has a field that contains a person name-related suffix. Typically, the clean inquiries engine 532 determines whether the “first name” field or the “spouse name field” of a particular inquiry request contains a person name-related suffix. A comparison between the text in the “first name” field or the “spouse name field” and suffixes contained in a table of suffixes determines whether the field of a particular inquiry request contains a person name-related suffix. One or more tables from the table database 546 may be accessed by the clean inquiries engine 532. For example, a table of suffixes called the “Initial Suffix Table” contains person name-related suffixes of conventional personal names that have been previously collected and stored in the table. For example, person name-related suffixes of conventional personal names can be “Jr.”, “Sr.”, “III”, “II”, “3^{rd}” and “2^{nd}”.

When the “first name” field or the “spouse name field” is determined to contain a person name-related suffix, the “YES” branch is followed to 804 as described above.

If the “first name” field or the “spouse name field” does not contain a person name-related suffix, then the “NO” branch is followed to 814.

In 814, a determination is made whether a particular inquiry request includes a field that contains an age or date of birth (DOB). Typically, the clean inquiries engine 532 determines whether the “spouse name field” of a particular inquiry request contains an age or date of birth (DOB). For example, the following text can be associated with an age or DOB: “age fifty”, “age 51”, “dob 6/8/35”, “2-3-65 dob”, “dob 8/68”.

When the “spouse name field” of a particular record is determined to contain an age or DOB, the “YES” branch is followed to 804 as described above.

If the “spouse name field” of the particular inquiry request does not contain an age or DOB, then the “NO” branch is followed to 816.

In 816, a determination is made whether a particular inquiry request includes a field that contains any embedded numbers. Typically, the clean inquiries engine 532 determines whether the concatenated name field of a particular inquiry request ends with a number greater than nine, whether the concatenated name field of the inquiry request contains an embedded number, and whether the “last name field” of the inquiry request contains an embedded number. This assignment filter permits correct coding of the inquiry request when a suffix is found at the end of the “first name field” since the “first name field” is not included in the suffix assignment filter in 512.

When a field of a particular inquiry request is determined to contain an embedded number, the “YES” branch is followed to 804 as described above.

If the field of a particular inquiry request does not have any embedded numbers, then the “NO” branch is followed to 818.

In 818, a determination is made whether a inquiry request includes a field that contains a truncated business-related word. Typically, the clean inquiries engine 532 determines whether the “first name field” contains a truncated or unconventional spelling of a business-related word. One or more tables from the table database 546 may be accessed by the clean inquiries engine 532. For example, a comparison between the text in the field and a list of truncated business-related words contained in a “Table of Business Abbreviations” determines whether the field of a particular inquiry request contains a truncated or unconventional spelling of a business-related word. The “Table of Business Abbreviations” contains a list of truncated or unconventional spellings of business-related words that have been abbreviated or otherwise shortened to fit within a field. For example, a truncated business-related word such as “Enterpris” can be matched to the abbreviation “Enterpris” for the business-related word “Enterprise” in the Table of Business Abbreviations. Note that this assignment filter handles abbreviated or otherwise shortened business-related words that have been entered in a field of a predefined size such as ten characters.

When a match is found for a truncated or unconventional spelling of a business-related word in the table, the “YES” branch is followed to 804 as described above.

If no match is found for a phrase in the table, then the “NO” branch is followed to 820.

In 820, a determination is made whether a particular inquiry request includes a field that contains one or more special characters. Typically, the clean inquiries engine 532 determines whether a particular inquiry request includes a concatenated name field that starts with or contains any special characters. One or more tables from the table database 546 may be accessed by the clean inquiries engine 532. For example, a comparison between the text in the field and a list of special characters contained in a “Table of Special Characters” determines whether the field contains any special characters. The “Table of Special Characters” contains a list of special characters. For example, special characters can include, but are not limited to, “&”, “#”, and “$”, or other non-alphabetic, non-numeric characters or symbols.

When a match is found for a special character, the “YES” branch is followed to 804 as described above.

If no match is found for any special characters in the table, then the “NO” branch is followed to 822. Note that in some instances if the special character is the last character in the field, then the clean inquiries engine 532 will not match the special character to the “Table of Special Characters”, and the “NO” branch is followed to 822.

In 822, a determination is made whether a particular inquiry request includes a field that contains a null field. Typically, the clean inquiries engine 532 determines whether a particular inquiry request includes a “first name field” that is null. When there is no first name in the corresponding field for a particular inquiry request, then the inquiry request is frequently associated with a business name. Analysis of the number of characters or words in the “last name field” determines the match code in 804.

When the first name field is null and the number of characters or words in the last name field has been determined, the “YES” branch is followed to 804 as described above.

If the first name field is not null, then the “NO” branch is followed to 824.

In 824, a determination is made whether a particular inquiry request includes a field that contains a person's first name. Typically, the clean inquiries engine 832 determines whether a particular inquiry request includes a “first name field” that contains a valid person's name. If there are no matching business-related words or phrases for the “first name field”, then the first name is compared to a list of persons' names in a “Name Attribute Table”.

One or more tables from the table database 546 may be accessed by the clean inquiries engine 532. For example, the Name Attribute Table contains first names that have been predetermined to be valid person's names. Persons' names that may be used in a “Name Attribute Table” can include, but are not limited to, “Abraham”, “Lloyd”, “Milan, and “Robert”.

When a match is found for a person's first name in the table, the “YES” branch is followed to 804 as described above.

If no match is found for a person's first name in the table, then the “NO” branch is followed to 826.

In 826, a determination is made whether a particular inquiry request includes a field that contains a default designation. Typically, the clean inquiries engine 532 determines whether a particular inquiry request includes a “FID field” that has a default character such as a “X”. When there is no “X” in the FID field for a particular inquiry request, then the inquiry request is associated with a person's name. When there is an “X” in the FID field for a particular inquiry request, then the inquiry request is associated with a business name.

Whether the FID field is determined to either have a default character or not, the branch is followed to 804 as described above, in which the subroutine 800 returns to 610 in FIG. 3.

FIG. 6 illustrates a subroutine 900 for filtering initial potential matches in a crunch file. A subroutine for filtering initial potential matches can include one or more matching methods, routines, subroutines or filters that can be executed by the search/match engine 542. Particular filters may be used for records that may contain only non-FCRA information, such as information originally collected or received by the grey data enrichment module 508, and not previously collected or received by the first-type module 506. These filters include “Name/Gender” filter, “Social/State/Region” filter, “Firm File Account Recency” filter, “Company Name Matching” filter, “Problem Code” filter; and “Duplicate Record” filter. Of these filters, certain filters can be used on records associated with a person's name, a business name, or to both types of records. The “Name/Gender” filter and “Social/State/Region” filter are applied to records associated with a person's name. “Social/State/Region” filter and “Firm File Account Recency” filter are applied to records associated with a business name. “Problem Code” filter; and “Duplicate Record” filter are applied to both types of records.

Other particular filters may be used for records that may contain both FCRA and non-FCRA information, such as information originating with the first-type module 506 and not originally collected or received by the grey data enrichment module 508. These filters include “Records that Cannot Be Alerted Due to FCRA Rules filter”, “Employment Matching” filter, “No Longer Employed” filter, and “FCRA data Firm Out of Business” filter. Of these filters, certain filters can be used on records associated with a person's name, a business name, or to both types of records. The “Records that Cannot Be Alerted Due to FCRA Rules filter” is applied to records associated with a person's name. “Employment Matching” filter, “No Longer Employed” filter, and “FCRA Data Firm Out of Business” filter are applied to either type of record.

A hierarchy in the sequence or order of the logic applied by the search/match engine can be important to streamlining the subroutine 900, though a specific order for executing the filters is not critical. For example, some filters only apply to records associated with a person's name and other filters only apply to records associated with a company or business name, while yet other filters apply to both types of records. Thus, thus a preferred embodiment of the subroutine 900 applies a company/person name type-filter near the beginning of subroutine.

The subroutine 900 includes one or more filters 902, 906-922. Typically, when a particular filter determines that a record satisfies a condition sought by the filter, a “YES” branch can be followed from each filter to 904. In 904, the subroutine 900 or particular filter 902, 906-922 codes the record with a match code corresponding the type of filter or condition that the filter sought to satisfy. If a condition is not satisfied by the filter 902, 906-922, the “NO” branch is followed to a subsequent filter to be applied. This process continues until a record is found satisfy at least one filter 902, 906-922, or the record does not satisfy any filter, and then the subroutine returns to 618 in FIG. 3. Each of the filters 902, 906-922 are described below.

In 902, inquiry only records are filtered from the remaining records. The search/match engine 542 filters all inquiry only records containing a particular code designated by an “Inquiry Only Records filter”. An Inquiry Only Records filter initially determines and eliminates records which have been previously processed and filtered, by another associated module, and then determines and eliminates any records that have been previously processed and filtered by the present module. The Inquiry Only Records filter reduces the size of the crunch file 544, and reduces the amount of time that the alert engine 548 or alerters may require in reviewing the crunch file 544.

Typically, an Inquiry Only Records filter is the first filter and the last filter to be processed for a set of candidate records in a crunch file 544. First, the Inquiry Only Records filter determines whether records were filtered in a prior processing run by another associated module such as the first-type module 506. For example, there are filters that can be processed by an associated module of the system that causes a crunch file 544 to be sent to the second-type module 510 with an inquiry request and no matching records. The filter identifies and codes these types of inquiry requests so that they can be removed from the crunch file 544.

Then, after all other filters are run by the second-type module 510, the Inquiry Only Records filter eliminates any orphaned inquiry request records. For example, when filters are processed by the second-type module 510, the inquiry requests will only have filtered records associated with them. Once the filters approve the records, there is no need to output these inquiry requests to the crunch file 544. These records are then coded by the Inquiry Only Records filter for removal from the crunch file 544.

In 906, records containing mismatched name/genders are filtered from the remaining records. The search/match engine 542 filters all records containing mismatched name/genders between the first name and the designated gender in the record. A filter such as a “Name/Gender filter” can be utilized by the search/match engine. This type of filter processes records believed to contain a person's name, reduces the size of the crunch file 544, and reduces the number of records that may need to be analyzed by the alert engine 548. Typically, this filter matches a portion of the first name in the inquiry request to a candidate record in the crunch file 544. The filter then determines whether a gender designation of the first name in the inquiry request matches a gender designation of the first name in the candidate record. When the gender designations do not match, the “false” positive can be eliminated from the crunch file 544.

The Name/Gender filter utilizes one or more tables containing first names generally associated with a particular gender, such as an “Internal Name Gender Table”. The Internal Name Gender Table includes first names associated with a particular gender or not associated with a particular gender, i.e. gender-neutral. The table can be accessed by the search/match engine 542 when processing the Name/Gender filter. For example, the name “Mark” or “Michael” can be generally recognized as a “male” gender name, whereas the name “Mary” or “Michelle” can be generally recognized as a “female” gender name. Other names are generally recognized as gender-neutral such as “Chris”. If the Name/Gender filter can obtain a gender determination based upon the first name in an inquiry, then other first names that are generally recognized as associated with the opposite gender can be excluded by the filter.

If the Name/Gender filter determines that the gender of the name in the inquiry request is different to the gender of a candidate record in the crunch file, then the candidate record and/or inquiry request can be coded to reflect this determination.

In some instances, if the social security numbers of the candidate record and the inquiry are equal, then the Name/Gender filter should not be processed, and the inquiry request and candidate record are considered to be a “hard” match with each other.

In 908, records including a problem code are filtered from the remaining records. The search/match engine 542 filters all records containing particular problem codes using a “Problem Code filter”. A problem code designates or otherwise identifies a problem or circumstance that does not trigger or warrant generating an alert to a customer. For example, a problem code can designate a particular product offering by a vendor, and can designate a record that should be filtered. Therefore, a record containing a problem code can be eliminated or otherwise filtered from the crunch file 544. The Problem Code filter assists in reducing the size of the crunch file 544, and reduces the number of records that may need to be analyzed by the alert engine 548 or alerter.

Furthermore, a problem code such as an exclusion problem code can identify a particular record that should not be filtered, or otherwise should be eliminated from further consideration by the system for a particular inquiry request. When an exclusion problem code is identified in a record, the problem code filter excludes the record from the crunch file 544, and no further filtering is performed on the record for a particular inquiry request.

Problem codes can be compiled and stored in a “Problem Code Table”. A Problem Code Table contains problem codes that can be filtered, problem codes that cannot be filtered, problem codes that cannot be filtered that apply to all records, and problem codes that cannot be filtered that apply to business records only.

In 910, employment-type records are filtered from the remaining records. In some instances, records may not contain employment-type information, and this filter can be bypassed. The search/match engine 542 filters all employment-type records containing particular employment data using an “Employment Record filter”. This type of filter reduces the size of the crunch file 544, and reduces the amount of time that the alert engine 548 or alerters may require in reviewing the crunch file 544. Typically, employment-type records in a crunch file 544 may have insufficient information to match an inquiry request. If these employment-type records do not have sufficient information for matching to an inquiry request, then the record should be removed from the crunch file 544.

For example, when an employment-type record is designated in a set of candidates but does not contain sufficient information to be considered a “true” match, the record cannot be used to alert a customer in response to an inquiry request. Some employment-type records contain no identification information to review, information such as spouse name, address, city, state, and zip code. The Employment Record filter categorizes employment-type records with no identification information into two sets, a first set of records with a social security number and a second set of records without a social security number. The first set of records with a social security number can be compared to the inquiry request because the social security number on an inquiry request can be compared and matched to candidate employment-type records. The second set of records cannot be sufficiently compared to the inquiry request because these records do not have a social security number to compare and positively match with the employment-type records.

When a record is processed through the Employment Record filter, the record and/or inquiry request can be coded to reflect the type of employment record, either first set with a social security number or second set without a social security number, and the relative amount of matching identifying information with an inquiry request if any. For example, the filter distinguishes between reemployment-type records that do not have a social security number, but have no matching identification information with an inquiry request, or do not have matching names with the inquiry request, or the inquiry request has no identification information to match against the employment-type record.

A second type of “Employment Record filter” removes employment-type records from the risk database 520 and/or from crunch file 544 when the records indicate that a particular individual no longer works with a company. Typically, these types of records are pre-coded with a specific problem code and can be filtered by searching the record for this problem code. Furthermore, some employment-type records may not be pre-coded, but rather have comments such as “terminated” or “no longer employed” and have not been updated by being pre-coded. Other similar comments or designations can be located and identified in an employment-type record. This filter identifies these comments and designations in employment-type records and removes these employment-type records from the crunch file 544.

In 912, a determination is made whether a company, business, or person name associated with the record matches a predetermined company, business, or person name. The search/match engine 542 applies a “Company/Person Name Matching” filter that determines if a matching company, business, or person name exists for a company, business, or person name associated with a particular record. This type of filter initially attempts to eliminate false positives based upon the quality of how a company, business, or person name matches to company, business, or person names in a “Company Name” file. For example, a record associated with a company name such as “International Financial Corporation” may be determined to be relatively more similar to the company name “International Farming Company” than the company name “Intern Framing Associates” when the first fifteen characters of “International Financial Corporation” match the first fifteen characters of the company name “International Farming Company”, compared with only the first six characters matching between “International Farming Company” and the company name “Intern Framing Associates”.

Next, the search/match engine 542 utilizes the filter to attempt a match of the words regardless of order to account for instances where a company, business, or person name may be rearranged or otherwise mis-arranged. For example, “Window Washing” may be considered relatively similar to “Washing Window” since the words “Window” and “Washing” in each name are spelled exactly the same but are merely juxtaposed.

Furthermore, the search/match engine 542 utilizes the filter to attempt a match of valid abbreviations for a word component in a company or business name. For example, the company name “ABC Mfg” may be considered a potential match of “ABC Manufacturing” when the abbreviation “Mfg” is recognizes as a valid abbreviation for the word component “Manufacturing” in the company name “ABC Manufacturing”.

In at least one embodiment, the search/match engine 542 utilizes Soundex processing to communicate a company name to the filter for processing. For example, if a company name is broken down to a number of Soundex combinations, and the number does not meet a predetermined threshold, then the module may require that a state be added to the inquiry. Another threshold may be added to require a city name or zip code, and so on.

A similar type of filter associated with business or company names can be implemented for firm codes. In a “Firm Code Matching Filter,” each company or business may be uniquely identified by a firm code such as an employer identification number or another preselected number or code. A determination can then be made whether a particular record contains a matching firm code or otherwise sufficient company or business information to match previously stored company or business information associated with a previously stored firm code. Similarly, a person may be uniquely identified by a taxpayer identification number or another preselected number or code. One embodiment is a social security number as explained in 914.

In 914, a determination is made whether a person's social security number matches the state that the social security number was assigned in. The search/match engine 542 executes a “Social, State, Region” filter to determine whether a social security number associated with a person's name and corresponding record matches the state or region a particular record is associated with. Initially, the “Social, State, Region” filter accesses a social security number table that can be obtained from the Social Security Bureau or another data source. Corresponding portions of social security numbers are compared in the table to determine a state or a region that the social security number originated from. A qualitative comparison of the state or region determination with the state or region that a particular record is associated with can then be made. For example, the first three digits of a person's social security number are usually assigned according to the particular state that a person is born in, i.e. “568” is associated with the state of “California”.

This type of filter can also determine a region or combination of states associated with a particular social security number. Typically, a region includes the state a particular social security number was assigned in or otherwise associated with, as well as adjacent states, or popular states that persons from a particular state relocate to such as a non-contiguous state, or other selections of states based upon one or more observations about a group or persons' behavior. For example, the filter could determine that a region associated with the state of New York could include the adjacent states of New Jersey, Connecticut, Pennsylvania, and Rhode Island, and could further include the state of Florida based upon the observation that some New York residents relocate to Florida. Another example of an observation of states that persons relocate from/to are “California” to “Texas”, and “California” to “Washington”. Other predetermined regions, groups of states, and observations can be implemented by this type of filter.

In 916, a determination is made whether a particular record is a duplicate record. The search/match engine 542 applies a “Duplicate Record” filter to exclude any duplicate records from the crunch file 544. Removal of duplicate records saves processing time during subsequent filter applications.

In 918, a determination is made whether a particular record is a relatively recent record. The search/match engine 542 applies a “Firm File Account Recency” filter to remove records that are associated with a customer account that has been inactive for a predetermined threshold of time. These types of records may contain information that cannot be considered reliable since the information cannot be updated since the customer account with the system 500 is not recent, and no further updates are available from the customer.

In 920, a determination is made whether a particular record is not FCRA alertable. The search/match engine 542 applies a filter that removes non-alertable records subject to the FCRA or another applicable credit reporting law or regulation. These types of records can then be filtered from the remaining records of the crunch file 544. Typically, the search/match engine 542 filters records that contain a predefined code designating a particular record as non-alertable due to the FCRA or another applicable credit reporting law or regulation. For example, a predefined code designating a particular record as a non-alertable due to the FCRA can be associated with the record by a module of the system 502 or otherwise by an operator or user of the system 502. A filter such as a “Records that Cannot Be Alerted Due to FCRA Rules filter” identifies these records and removes these records from the crunch file 544. These types of records cannot be disclosed to non-FCRA entities. A non-FCRA entity is an entity or business that is not subject to the Fair Credit Reporting Act (FCRA) or some other applicable law, regulation, or statute relating to the disclosure and reporting of credit information. This type of filter reduces the size of the crunch file 544, and reduces the amount of time necessary to review and analyze the number of records in the crunch file 544.

In at least one embodiment, the search/match engine 542 utilizes Soundex processing to determine whether a potential match exists between the inquiry and one or more records in the inquiry portfolio database.

In 922, a determination is made whether a particular record is associated with a FCRA firm or business that is no longer in business. The search/match engine 542 utilizes a “No Update Available from Reporting Firms” filter to remove records associated with companies or businesses that are no longer viable concerns. This type of filter reduces the size of the crunch file 544, and reduces the amount of time that the alert engine 548 or alerters may require in reviewing the crunch file 544. Typically, companies or businesses provide data about other companies to the system in accordance with the FCRA or another applicable credit reporting law or regulation. In some instances, the data providers may no longer be in business or otherwise cannot provide the system with updated information about companies initially reported upon and stored in records with the system. This type of filter processes the company or business name in crunch file 544 records against a “No Longer in Business List of Companies” that includes firm names of companies that are no longer in business or otherwise cannot provide updated information.

Other filters for the subroutine 900 can exist. For example, in at least one embodiment, a Federal Tax ID Number filter can be used to determine whether a particular company name matches the state. In another embodiment, a “Fiduciary Account” filter can be used to determine whether a particular fiduciary or fiduciary tax identification number associated with a record can filter or match the record.

FIG. 7 is a flowchart for another method in accordance with various embodiments of the invention. The method 1000 is adapted to determine a potential match of search information in response to a pre-existing inquiry request from a customer. Typically, the method 1000 is a set of computer-executable instructions that can be implemented by the system 500 or by a combination of modules 506-510 described above. New inquiry requests transmitted to the second-type module 510 can be handled by another method, previously shown and described in FIG. 3.

In 1002 the method 1000 begins.

1002 is followed by 1004, in which a lookback is initiated. A lookback is a process that implements a command or instruction that is typically a part of an inquiry request that has been previously transmitted by a customer 512. The lookback can include a watch list or an update request submitted as part of an inquiry request. In a “lookback” process, a customer can submit a command or instruction to search or otherwise update the inquiry request on a predetermined basis. The “lookback” process may operate in conjunction with a “watch list” process, in which a customer can submit a list of items as part of an inquiry request. A watch list can contain one or more items such as names or other pieces of information that a customer wants to constantly monitor and be notified if a potential match, direct match, or a change in status information associated with the name or piece of information occurs. For example, in a “watch list” process, a customer may submit a watch list to the GRID module 510 as an inquiry request. A watch list can contain one or more items such as names or other pieces of information that a customer wants to constantly monitor and be notified if a potential match, direct match, or a change in status information associated with the name or piece of information occurs. The watch list is stored in the inquiry portfolio database 536, and the search/match engine 542 monitors the new GRID daily grey file 540 for recent record or file entries to see if a potential match for relevant information exists. As a further aspect of a “watch list” process, a customer may submit an update request as part of an inquiry request. An update request is a request by the customer to respond immediately, on a predetermined basis such as a continuing or ongoing basis, or on a periodic basis with information regarding a watch list item or a name. A particular update request for an inquiry request may also depend upon a customer's need for information regarding a particular inquiry request. The update request is stored as part of the customer's portfolio in the inquiry portfolio database 536. The search/match engine 542 tracks the update request and monitors the new GRID daily grey file 540 in accordance with the customer's update request to determine if a potential match for relevant information exists. The search/match engine 542 generates update information that corresponds to the update request and includes any new information that the search/match engine 542 locates in response to the customer's update request. Other processes similar to those described above can trigger a lookback as described in 1004.

1004 is followed by 1006, in which recent records are compared to a stored inquiry request. Typically, the search/match engine 542 compares a stored inquiry request against relatively recent record or file entries stored in the new GRID daily grey file 540 to see if a potential match for relevant information exists. In most instances, depending upon the recency of the information and the customer's predetermined basis, the grey database 538 does not have to be searched in order to update the potential matches for a particular inquiry request.

1006 is followed by 1008, in which initial potential matches are stored. Similar to 612, any matching records or files are copied to a crunch file 544 for further processing.

1008 is followed by 1010, in which the initial potential matches are filtered. Similar to 614, one or more filters is applied to the crunch file 544 to remove false positive matches and to reduce the size of the crunch file 544.

1010 is followed by 1012, in which remaining records are analyzed. Similar to 616, the alert engine 548 or alerters analyze the remaining records in the crunch file 544.

1012 is followed by decision block 1014, in which a determination is made whether a particular remaining record matches the inquiry request. Similar to 618, the alert engine 548 or alerters determine whether a particular record in the crunch file 544 is a positive match to the inquiry request. If a positive match is made, then the “YES” branch is followed to 1016.

In 1016, the customer is alerted of the positive match. Similar to 620, the alert engine 548 or alerter generates an alert and transmits the alert to the customer 512 initiating the inquiry request. The alert database 550 can then store a record of the alert and any associated information transmitted to the customer 512.

1016 is followed by 1018, in which the method 1000 ends.

Returning to decision block 1014, if a particular record is determined not to be a positive match, then the “NO” branch is followed to 1020. In 1020, the particular record is removed from the crunch file.

After 1020, the method 1000 returns to 1012. The method 1000 continues as described above until the crunch file 544 is exhausted, and the customer 512 is either alerted or not alerted with respect to a particular inquiry request.

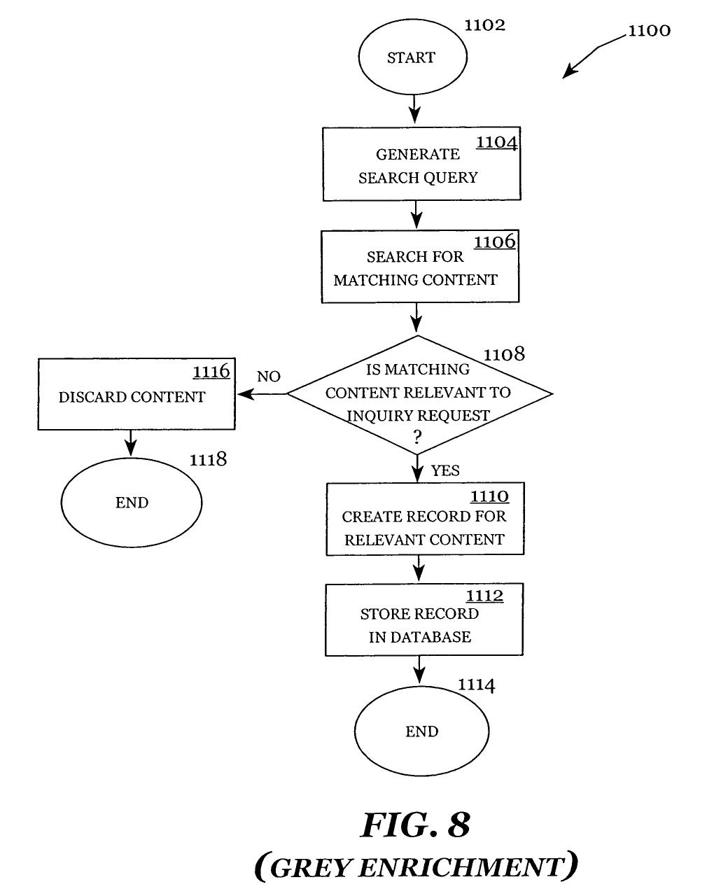

FIG. 8 is a flowchart for another method in accordance with various embodiments of the invention. The method 1100 is adapted to collect or otherwise receive information via a network 504 and store selected information in an associated database for subsequent retrieval. Typically, the method 1100 is a set of computer-executable instructions that can be implemented by the grey data enrichment module 506 of the system 502 described above.

The method 1100 begins at 1102.

1102 is followed by 1104, in which a search query is generated. The search engine 518 forms a query from one or more keywords, relevant phrases, alphanumeric characters, or a combination thereof from information contained in a customer's inquiry request. Conventional methods, routines, subroutines, and search processes are used to generate a query from information contained in an inquiry request, or otherwise associated with information in the inquiry request. For example, an inquiry request stored in the inquiry portfolio database 536 may contain a business or company name. The search engine 518 can generate a query using the business or company name from a particular inquiry request, and from also using cataloged or predetermined keywords, relevant phrases, or other information related to the business or company name.

The functions of the search engine 518 can also be manually performed by an operator associated with the grey data enrichment module 508. An operator could select keywords, relevant phrases, or other information related to an inquiry request, and manually generate a search query for the search engine 518, or for his or her own manual search.

1104 is followed by 1106, in which the query is utilized to search for matching information. The search engine 518 communicates via a network 504 to access one or more data sources 530 or other third-party databases or data storage devices. One or more queries can then be utilized to locate matching information in a data source 530. Matching information in response to a query can then be collected, stored, or otherwise imaged for subsequent access or transmission. For example, if the search engine 518 locates matching information to a query in an article in a data source 530 such as the New York Times publications database, a scanned image of the article can be stored in the image or ISYS database 526 for later retrieval.

The functions of the search engine 518 can also be performed manually by an operator associated with the grey data enrichment module 508. An operator can manually search data sources 530 or other third-party databases or data storage devices via the network 504. When matching information is located in response to the query, the operator can collect, store, or otherwise image the information for subsequent access or transmission.

1106 is followed by decision block 1108, in which a determination is made whether the matching information is relevant to the inquiry request. In many instances, matching information may not be relevant to the inquiry request, and such information should not be used in relation to the inquiry request. The archive engine 524 determines whether matching information is relevant to the inquiry request. The archive engine can parse, document, index, and process collected or received matching information from the search engine 518 to determine whether the information is relevant to the inquiry request. A determination can also be performed manually by an operator associated with the grey data enrichment module 508. If the matching information is determined to be relevant to the inquiry request, then the “YES” branch is followed to 1110.

In 1110, a record is created for the matching relevant information. The archive engine 524 processes the information into defined location information and abstract information, and creates a unique record containing this information. Location information can be a network address, Internet address, website, webpage, hyperlink, link, or other pointer or location information that is associated with information collected or otherwise received by the search engine 518. Abstract information can be an abstract of an article or document, a combination of a relevant keyword, phrase, or other specific information that is associated with information retrieved or otherwise located by the search engine 518. As discussed above, the functions of the archive engine 524 can also be manually performed by one or more operators or persons.

Raw or scanned images of documents, articles, or other information collected or received by the search engine 518 can also be part of a record. Images are typically stored in the image or ISYS database 526, accessible as a part of the record at a later time.

For example, an article located on the Internet may have information relating to Joseph Doaks and the business that he operates, Doaks, Inc. The archive engine 524 may select keywords such as the name “Joseph Doaks,” and the name of his business, “Doaks, Inc.” A record can then be created for the person's name, Joseph Doaks, and the record can be associated with the keywords of “Joseph Doaks” and “Doaks, Inc.” Abstract information such as a brief summary of the article can be included with the record, such as “Daily news article regarding Joseph Doaks' business, Doaks, Inc.” Location information such as the Internet address or link to the article can also be associated with the record.

1110 is followed by 1112, in which the record is stored. The archive engine 524 stores the record containing location information and abstract information in the risk database 520 or the new daily grey file 522, depending upon the recency of the information. A record can include a pointer file containing location information, an abstract file containing abstract information, and a link to an image in the image or ISYS database 526. The record may be indexed one or more relevant keyword or phrases selected by the archive engine 524 for subsequent searches in the risk database 520 or new daily grey file 522. As discussed above, the functions of the archive engine 524 can also be manually performed by one or more operators or persons.

1112 is followed by 1114, in which the method 1100 ends.

Referring back to decision block 1108, if matching information is determined not to be relevant to the inquiry request, then the “NO” branch is followed to 1116.

In 1116, the matching information is discarded.

1116 is followed by 1118, in which the method 1100 ends.

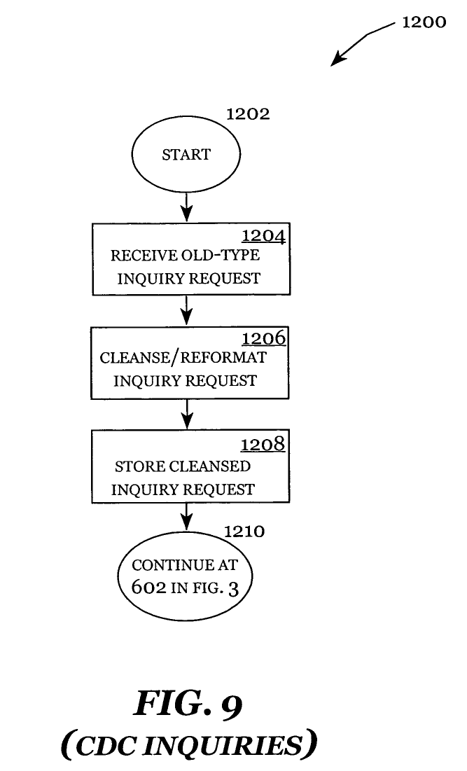

FIG. 9 is a flowchart for another method in accordance with various embodiments of the invention. The method 1200 is adapted to receive an old, conventional type of inquiry request via the first-type module 506, and to cleanse the inquiry request for processing by the second-type module 510. Typically, the method 1200 is a set of computer-executable instructions that can be implemented by the first-type module 506 of the system 502 described above.

In 1202, method 1200 begins.

1202 is followed by 1204, in which an old-type inquiry request is received. As described above, a conventional, old-type inquiry request cannot be ordinarily handled by the second-type module 510, and should be processed by the first-type module 506 prior to transmission to the second-type module 510 for matching. Typically, the inquiry processing engine 514 receives an old-type inquiry request from a customer 512 via the network 504. The inquiry processing engine 514 handles the old-type inquiry request and processes the inquiry request for transmission to the I-File 516 or another inquiry database.

1204 is followed by 1206, in which the old-type inquiry request is cleansed. In some instances, an old-type inquiry request can by cleansed or otherwise reformatted into a new-type of inquiry request. The inquiry processing engine 514 reformats old-type inquiry requests received by the first-type module 506 into a new, standard format of inquiry request that can be stored by the I-File 518 or otherwise transmitted to the second-type module 510 for matching.

To clean an inquiry request, name fields must be identified. Utilizing conventional concatenation rules, the inquiry processing engine 514 concatenates text contained in one or more identified fields for character identification and matching described in one or more subsequent assignment subroutines previously disclosed.

In other instances, an old-type inquiry request may have to be re-keyed or re-entered into a new, standard format that can be stored by the I-File 516 and later transmitted to the second-type module 510 for matching. Generally, an operator associated with the first-type module 506 can review an old-type inquiry request and re-key pertinent information from the old-type inquiry request into a new-type inquiry request.

1206 is followed by 1208, in which the reformatted inquiry request is stored. Generally, all inquiry requests that are reformatted by the inquiry processing engine 514 are stored in the I-File 516. The reformatted or new-type inquiry request can be subsequently retrieved and transmitted by the inquiry processing engine 514 to the second-type module 510 for matching.

1208 is followed by 1210, in which the method 1200 goes to 602 in FIG. 3. Since the inquiry request initially received by the first-type module 506 is reformatted into a new-type format compatible with inquiry requests ordinarily received by the second-type module 510, then the reformatted inquiry requests can also be processed according to the method already described in FIG. 3 as 600.

FIG. 10 illustrates a system according to various embodiments of the invention for processing, distributing, and analyzing crunch files. The system is an electronic crunch system 1300 that includes an incoming file queue 1302, one or more supervisory stations 1304, one or more alerter queues 1306, one or more corresponding alerter stations 1308, and an outgoing file queue 1310. Components 1302-1310 of the electronic crunch system 1300 illustrated in FIG. 10 operate in conjunction in accordance with methods in accordance with various embodiments of the invention. In particular, one method used with the system 1300 is known as “BizFlow,” and is further illustrated and described in FIG. 11. Another method used with the system 1300 is known as “eCrunch” and is further illustrated with respect to FIGS. 12-20. The electronic crunch system 1300 may operate as a part of or in conjunction with the alert engine 248 of FIG. 2, or otherwise be in communication with the second-type module 210 or system 200 of FIG. 2.

The electronic crunch system 1300 is adapted to receive an incoming crunch file, distribute the crunch file to an alerter, and to permit the alerter to analyze and process the crunch file to filter any false positive matches. As described above in FIGS. 1 and 2, a crunch file is a set of records or files that contain one or more possible matches to an inquiry request, such as false positives, a positive matches, and other types of matching records or files. The electronic crunch system 1300 typically processes one or more incoming crunch files. Initially, incoming crunch files prioritized and distributed to a respective alerter queue 1306 based upon an automatic or manual assignment of a priority based on at least one criteria or characteristic of the respective crunch file. A criteria or characteristic can be defined by a user or operator. An operator such as a supervisor can access the incoming crunch file via a supervisory station 1304 to evaluate the crunch file and to assign a priority or set at least one criteria to be assigned to a crunch file. Once an incoming crunch file is received by an alerter queue 1306, another operator such as an alerter can access the crunch file in the alerter queue 1306 via a respective alerter station 1308. The alerter station 1308 can provide one or more electronic tools for an alerter to further process or otherwise analyze the crunch file. Once the crunch file is processed by an alerter, the processed crunch file is distributed from an alerter station 1308 to an outgoing file queue 1310. In some instances, a user such as a supervisor can utilize a supervisory station 1304 to perform additional analysis on a particular crunch file to validate the effectiveness of one or more previously applied filters or subroutines.

An incoming file queue 1302 is adapted to receive one or more incoming crunch files. One or more crunch files in the incoming file queue 1302 can be automatically distributed or manually distributed to one or more alerter queues. Typically, an incoming file queue 1302 is a file storage component in a system including an associated electronic database. In most instances, an incoming file queue 1302 is linked to one or more supervisory stations 1304. The incoming file queue 1302 can be monitored by one or more supervisors operating a respective supervisory station 1304. As a crunch file is received by the incoming file queue 1302, the crunch file can be automatically or manually processed by a supervisor and/or supervisory station 1304.

A supervisory station 1304 is adapted to track incoming crunch files and distribute crunch files from the incoming file queue 1302. The supervisory station 1304 can be a processor-based platform, such as a workstation, desktop, computer, personal digital assistant (PDA), or similar type platform, in communication with an incoming file queue 1302, one or more alerter queues 1306 or respective alerter stations 1308. Typically, a supervisory station executes a software routine or set of computer-executable instructions to provide one or more electronic tools for a supervisor operating the supervisory station 1304. The electronic tools permit a supervisor operating a supervisory station 1304 to prioritize crunch files; to define criteria or characteristics for automatic distribution of crunch files to one or more alerter queues 1306; to move a particular crunch file from one alerter queue 1306 to another or different alerter queue 1306; to monitor the progress of one or more alerters operating respective alerter stations 1308 through reports or statistics associated with crunch files processed by a respective alerter station 1308; to monitor progress of crunch file processing through reports or statistics associated with crunch files handled by alerter queues 1306, the incoming file queue 1302, and/or the outgoing file queue 1310; and to perform additional analysis on a particular crunch file to validate the effectiveness of one or more previously applied filters or subroutines. Statistics that can be monitored can include, but are not limited to, number of unprocessed inquiries, number of inquiries processed and marked as false positive, number of inquiries processed and marked as an alert, number of inquiries under investigation by an alerter, and total number of grey records.

For example, a supervisor operating a supervisory station 1304 can view an associated display device (not shown) showing one or more incoming crunch files received by the incoming file queue 1302 in order to evaluate the content of each incoming crunch file. Each incoming crunch file can then be prioritized based on at least one predetermined criteria or characteristic. The supervisor associated with the supervisory station 1304 can assign a criteria or characteristic either manually, by reviewing each incoming crunch file and selecting a predetermined criteria or characteristic; or automatically, by assigning a criteria or characteristic by way of a routine or set of computer executable instructions that selects or otherwise determines a criteria or characteristic for the incoming crunch file. The supervisor can then provide instructions at or to the supervisory station 1304 to distribute an incoming crunch file according to a predefined or otherwise selected criteria or characteristic.

A decision to distribute the crunch file to a particular alerter queue 1306, alerter station 1308 or alerter can be based on at least one criteria or characteristic assigned to the crunch file. After the crunch file is assigned at least one criteria or characteristic, the crunch file can be distributed to an alerter queue 1306 associated with a particular alerter station 1308 or alerter. For example, a particular crunch file may be assigned a “high” priority, and then be distributed to an alerter queue 1306, alerter station 1308 or alerter that handles “high” priority crunch files to other requests.

In another example, a supervisor operating a supervisory station 1304 can view an associated display device (not shown) showing one or more incoming crunch files received by the incoming file queue 1302 in order to analyze the effectiveness of a previously applied filter or subroutine in filtering particular information from an incoming crunch file. The supervisor can utilize the analysis to determine whether to validate the results of a previously applied filter or subroutine, or to adjust or otherwise provide improvements to the filter or subroutine for subsequent filtering of crunch files.

An alerter queue 1306 or “work-item queue” is adapted to receive and store one or more incoming crunch files from the incoming file queue 1302. Typically, an alerter queue 1306 is a file storage component associated with an alerter station 1308. The alerter queue 1306 can be adapted to be an individual queue associated with a respective alerter station 1308 as shown in FIG. 10; or alternatively, can be a group queue that distributes to one or more alerter stations. In either configuration, as each crunch file is received by the alerter queue 1306, the crunch files can be further prioritized based upon an assigned criteria or characteristic associated with the crunch file. The crunch files in the alerter queue 1306 can then be automatically distributed or manually distributed to an alerter station 1308 based on a predefined or otherwise selected criteria or characteristic.

The alerter queue 1306 can be monitored by an operator such as an alerter operating an alerter station 1308. As a crunch file is received by the alerter queue 1306, the crunch file is stored by the alerter queue 1306 until called upon to be automatically or manually processed by the alerter station 1308. The alerter station 1308 may call upon a particular crunch file in the alerter queue 1306 depending upon a previously assigned criteria or characteristic associated with the crunch file.

An alerter station 1308 is adapted to receive crunch files from an alerter queue 1306, and to track incoming crunch files received from an alerter queue 1306. The alerter station 1308 can be a processor-based platform, such as a workstation, desktop, computer, personal digital assistant (PDA), or similar type platform, in communication with at least one supervisory station 1304, and one or more alerter queues 1306. In the instance that an alerter queue 1306 is a group queue, one or more alerter stations 1308 are linked to the single group queue. In the instance that an alerter queue 1306 is one or more individual alerter queues, a respective alerter station 1308 is linked to each alerter queue 1306. Typically, an alerter queue 1306 is linked to at least one alerter station 1308. An operator such as an alerter operates an alerter station 1308, and can view an associated display device (not shown) to evaluate the content of one or more incoming crunch files received by the alerter queue 1306. The alerter can provide instructions at or to the alerter station 1308 to process the incoming crunch file. For example, each incoming crunch file to an alerter station 1308 can be processed in accordance with a predetermined crunch assignment. The alerter can use one or more electronic tools provided by the alerter station 1308 to process the incoming crunch file. When the alerter has processed the incoming crunch file, the crunch file can then be submitted for processing by other components of the system 1300.

An alerter associated with an alerter station 1304 can process an incoming crunch file using one or more electronic tools provided by a software routine or set of computer-executable instructions being executed by the alerter station 1308 or on another platform. For example, a software program, such as “Electronic Crunch” or “eCrunch,” can provide online-accessible electronic tools for an operator or alerter to view for particular crunch files, the inquiry requests and their associated grey records; to organize data fields in a crunch file in the same order as a pre-existing printed format; provide various viewing options for organizing data fields of inquiry requests and grey records to allow comparison of an inquiry request with one or more grey records; to mark irrelevant grey records and hide them from a current view or display; to store notes on calls and investigations performed for a particular crunch file, to assign a status to an inquiry request; and to view other types of content of a crunch file on an associated display screen. Content of a crunch file can include, but is not limited to, an inquiry request and associated grey records, data fields in an order similar to an existing printed format, highlighted fields to allow comparison of information, previously marked irrelevant records. Exemplary screenshots of a software program providing online-accessible tools for an alerter operating an alerter station 1308 are shown and described in FIGS. 12-16.

The software program or other set of computer-executable instructions can provide a network browser user interface, such as those implemented in a local area network or the Internet. Furthermore, web services technologies, such as XML, XSLT, Xpath, JAVA, and JAVAScript, can be utilized to permit integration with the electronic crunch system 1300. Other conventional systems and operations such as Tfile output formats and defined extensions, as well as pre-existing database formats can be supported by the software program or other set of computer-executable instructions.

An outgoing file queue 1310 is adapted to receive one or more outgoing crunch files. After an incoming crunch file has been processed by an alerter station 1308, the crunch file is transmitted to the outgoing file queue 1310 for further processing by the electronic crunch system 1300. The crunch files in the outgoing file queue 1308 can be automatically transmitted or manually transmitted from one or more alerter queues 1306 and/or associated alerter stations 1308. Typically, an outgoing file queue 1310 is a file storage component in a system including an associated electronic database. The outgoing file queue 1310 can be monitored by an operator such as a supervisor operating a supervisory station 1304. One or more supervisors may be monitoring the outgoing file queue 1310. As a crunch file is received by the outgoing file queue 1310, the crunch file can be automatically or manually processed by one or more supervisors operating a respective supervisory station 1304. For example, one or more records in a processed crunch file may be assigned an “alert” status indicating that the particular records in the processed crunch file are confirmed “positive” matches to an inquiry request. A supervisor operating a supervisory station 1304 may initiate an alert report to transmit the particular records directly to a customer associated with the inquiry request.

FIG. 11 illustrates a subroutine for further processing crunch files and generating an alert in accordance with various embodiments of the invention. The method 1400 begins at 1402.

1402 is followed by 1404, in which an incoming crunch file is received. Typically, an incoming crunch file is received in an incoming file queue 1302. One or more incoming crunch files can be received and handled by the incoming file queue 1302.

1404 is followed by 1406, in which the incoming crunch file is prioritized. At least one priority can be assigned to an incoming crunch file based on a criteria or characteristic. More than one priority may be assigned to a crunch file depending upon a previously selected priority, or a particular criteria or characteristic associated with the crunch file. Each priority can be assigned automatically by the system 1300 and/or manually assigned by an operator such as a supervisor operating a supervisor station 1304.

1406 is followed by 1408, in which the incoming crunch file is distributed based on an assigned priority. Typically, the incoming crunch file is distributed to an alerter queue 1306 based on an assigned priority. Depending upon the priority, a crunch file can be sorted or otherwise distributed to a particular alert queue 1306 for further processing. For example, particular crunch files assigned with a specific priority can be distributed to a specific alerter queue 1306.

1408 is followed by 1410, in which the crunch file is processed by an alerter station. When the incoming crunch file is distributed to an alerter queue 1306 based on an assigned priority, a respective alerter station 1308 can access the incoming crunch file in the alerter queue 1306 to process the crunch file. Typically, an alerter associated with the alerter station 1308 reviews content of the incoming crunch file via an associated display screen. The alerter can then utilize a set of electronic tools provided by a software program or computer-executable instructions to analyze and process grey records associated with the incoming crunch file. When the alerter has processed the crunch file, the crunch file can be further processed by the system 1300.

1410 is followed by 1412, in which the processed crunch file is transmitted to an outgoing file queue 1310. Processed crunch files are transmitted and stored at the outgoing file queue 1310 until called upon for further processing by the system 1300. Further processing can include, a supervisor operating a supervisory station 1304 to initiate an alert report to a customer containing one or more identified grey records in a processed crunch file that are responsive to a customer's inquiry request.

1412 is followed by 1414, in which the method 1400 ends.

FIGS. 12-16 illustrate screenshots of a software program providing online-accessible tools for an alerter or a supervisor.

FIG. 12 illustrates a webpage 1500 for an inquiry review. The webpage 1500 provides a tool bar 1502, and an information field 1504. The tool bar 1502 includes a menu of one or more user options, such as “Crunch File,” “View,” “Print,” “Tools,” and “Help.” The information field 1504 can include at least one record 1506, a corresponding status indicator 1508, a corresponding grey item indicator 1510, a statistical box 1512, and a record indicator 1514.

Typically, an inquiry review provides the webpage 1500 at an alerter station 1206 for a user such as an alerter to view one or more records such as inquiry requests associated with or from one or more particular customers. Upon request, one or more records 1506 can be displayed in the information field 1504. A record or inquiry request can include one or more columns of information, such as social security number, taxpayer identification number, last name, first name, spouse name, FRM, BRN, account number, sales, date, address, city, state, zip code, or other information.

User options for a tool bar 1502 are generally global-type commands available to a user such as an alerter or supervisor for a particular webpage. Typically, these user options are administrative functions that assist a user in storing, printing, or obtaining assistance for a particular webpage.

A corresponding status indicator 1508 conveys status information relating to the record. Status information associated with a key can be conveyed by an alphanumeric symbol, such as “O” for an “open inquiry request,” “N” for an inquiry request that has “not been alerted,” “R” for an inquiry request that requires “research to be performed,” “A” for an inquiry request in which an “alert has been generated” for a customer, and “E” to indicate that an inquiry has been “escalated.”

Depending upon the status information associated with a particular record or inquiry request, each record or inquiry request can be color-coded according to the particular status of each record or inquiry request. For example, a status indicator 1508 may indicate whether the status of a particular inquiry request or record is “open,” “not-alert,” “research,” “alert,” or “escalate.” A unique color corresponds to each status condition, such as red for “alert,” or green for “open,” etc. The inquiry requests may be organized and displayed according to an associated status, and the use of user-friendly features, such as color-coding, provide a user or operator with the ability to readily recognize, organize, or otherwise group together particular inquiry requests or records based on their respective status condition. When a particular inquiry request is subsequently selected for analysis or comparison, the inquiry request may maintain its color coding in subsequent screens.

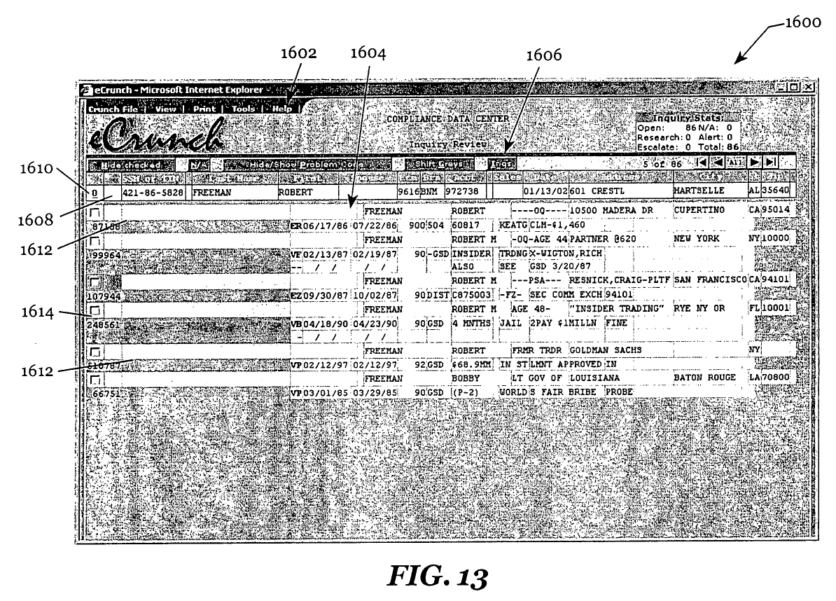

A corresponding grey item indicator 1510 adjacent to the corresponding status indicator 1508 provides the number of associated grey records for the particular record shown. For example, a particular inquiry request or record may have 6 grey records that have been previously identified as being particularly relevant to the inquiry request or record. The corresponding grey item indicator 1510 indicates the number of identified grey records, 6 in this example. The corresponding grey item indicator 1510 can provide a direct link to subsequent webpages, such as that illustrated and described in FIG. 13, showing each identified grey record in greater detail.

A statistical box 1512 displays statistical information related to the records shown in the information field 1504. Typically, the statistical information is associated with the information provided by the corresponding status indicator 1508. For example, a statistical box 1512 labeled “Inquiry Stats” can display the total number of “open inquiry requests,” the total number of inquiry requests that have “not been alerted,” the total number of inquiry requests that require “research to be performed,” the total number of inquiry requests in which an “alert has been transmitted” to a customer, and the total number of inquiry requests that have been “escalated.”

A record indicator 1514 displays record and webpage information. For example, if there the records or inquiry requests for a particular instance cannot fit within the space provided by the information field 1504, additional webpages may be needed to display the records or inquiry requests. The record indicator shows the number of records on a current webpage, and the total number of records for a particular instance. The record indicator can provide options to move forward through subsequent webpages, backward through previous webpages, or to display all records in a single webpage.

Additional functionality (not shown) may provide an operator, such as alerter, the capability to display records excluded by or otherwise identified by previously applied filters or subroutines. This functionality provides an analysis tool for determining the relative effectiveness of a filter or subroutine. Subsequent improvements to the filter or subroutine can then be made.

FIG. 13 illustrates a webpage 1600 for an inquiry review. The webpage 1600 provides greater detail of grey records associated with a particular inquiry request. As described in FIG. 12, an inquiry request can have a corresponding grey item indicator 1510. When a user such as an alerter or supervisor selects a link associated with the grey item indicator 1510, a webpage such as 1600 can be displayed showing each grey file that has been previously identified as containing particularly relevant information. A user can then view, analyze, or otherwise obtain greater detail of each grey file as needed. The user may then make a decision about one or more of the grey files, such as approving the grey files for a report or alert to be sent to a customer associated with the inquiry request.

The webpage 1600 provides a tool bar 1602, an information field 1604, and a display bar 1606. The tool bar 1602 includes a menu of one or more user options, such as “Crunch File,” “View,” “Print,” “Tools,” and “Help.” The information field 1604 can include a selected inquiry request or record 1608, a corresponding status indicator 1610, at least one corresponding grey file 1612, and a grey file check box 1614. The display bar 1606 includes a menu of additional user options for the webpage 1600, such as “Hide Checked,” “N/A,” “Hide/Show Problem Code,” “Shift Greys,”, and “Inqs.”

Similar to the tool bar 1502 in 1500, a tool bar 1602 provides user options that are generally global-type commands available to a user such as an alerter or supervisor. Typically, these user options are administrative functions that assist a user in storing, printing, or obtaining assistance for a particular webpage.

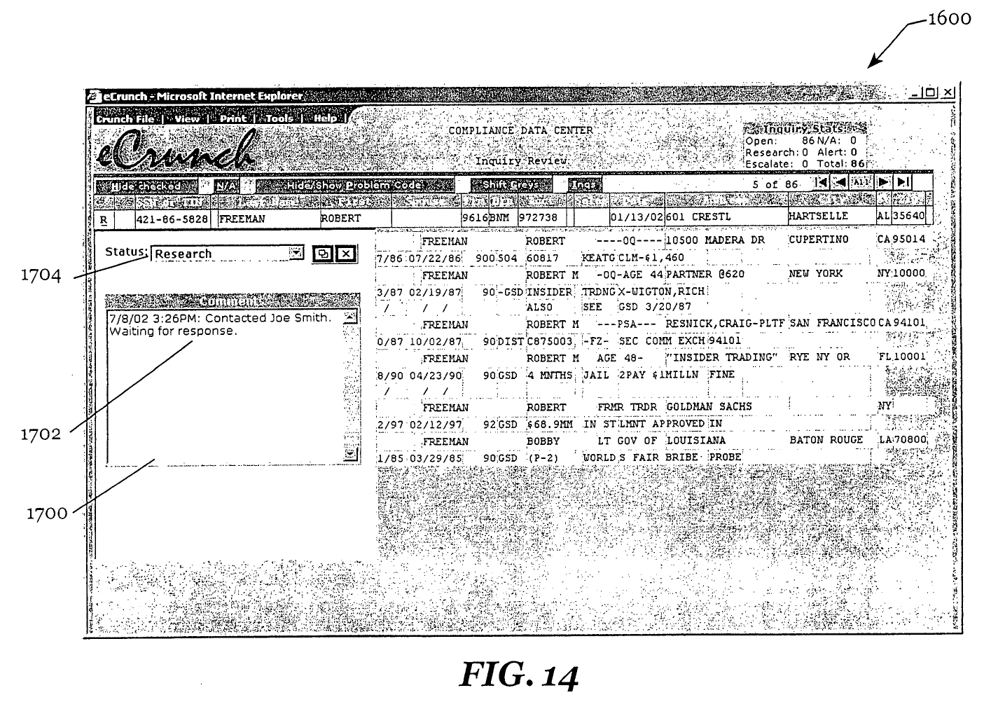

An information field 1604 provides detail of each corresponding grey file for a particular inquiry request or record. Near the upper portion of the information field 1604, a selected inquiry request or record 1608 is displayed for comparison to each grey file 1612. One or more grey files 1608 can be displayed adjacent to or below the inquiry request or record 1608 so that details of each grey file 1612 can be compared with the inquiry request or record 1608. As a user or operator analyzes a selected inquiry request or record 1608 in subsequent screens, the selected inquiry request or record 1608 may maintain a stationary position near the upper portion of the information field 1604 so that the user or operator can readily refer to the content of the selected inquiry request or record 1608 for comparison to grey files or records. Details that can be included with each grey file 1612 are first name, last name, age, address, date of birth, date of information, employment, position, and other associated information. A status indicator 1610 adjacent to the inquiry request or record 1608 provides an indication of a particular status of the inquiry request or record 1608. The status indicator 1610 can be changed by the user as needed. For example, “O” indicates that the inquiry request or record is “open” for analysis. If the user highlights the status indicator 1610, and selects a different status such as “R” to perform additional research, then the status indicator 1610 can provide a direct link to subsequent webpages, such as that illustrated and described in FIG. 14.

A grey file check box 1614 adjacent to each grey file 1612 provides a feedback tool for a user to select or otherwise highlight a particular grey file 1612. For example, if a user desires to designate a particular grey file for additional analysis or research, the user can check a respective grey file check box, and then a user option can be performed with respect to the designated grey file.

Additional user options provided by the display bar 1606 permit a user to select commands for previously designated grey files. A user option such as “Mark All” permits a user to check all the grey file check boxes displayed on the webpage. The user option “Remove All” permits a user to remove any and all previously entered checks in the grey file check boxes. The user option “Hide Checked” permits a user to remove selected grey files from the current webpage or instance. Another user option such as “N/A” permits a user to set the status of designated grey files between not-alert and alert. Yet another user option such as “Hide/Show Problem Code” permits a user to remove or display a problem code for designated grey files. For example, some grey files may be associated with a problem code that identifies the file as from a troubled account or otherwise containing information from an unreliable or questionable source. These types of grey files can be temporarily removed from the current webpage or instance. The user option “Shift Greys” permits a user to align or move the relative position of designated grey files with respect to other grey files. The user option “Inqs” permits a user to view a particular inquiry request or record associated with a designated grey file.

FIG. 14 illustrates a window 1700 associated with a webpage for an inquiry review. The window 1700 appears over the webpage of 1600, and provides research information and additional user commands for designated grey files associated with a particular inquiry request. As described in FIG. 13, an inquiry request or record 1608 can have an associated status indicator 1610. When the status indicator 1610 is highlighted in 1600, and changed to “R” for research, a pop-up window 1700 is generated and overlaps a portion of the webpage 1600. A user can then view, analyze, or otherwise obtain greater detail of research performed for the inquiry request or record 1608 as needed. For example, previously entered details about research performed for the inquiry request or record 1608 can be displayed in a “Comments” field 1702. The user may then make a decision about the inquiry request or record 1608, such as changing the status associated with the inquiry request or record 1608. In the example shown, the status indicator 1610 is shown as “R” designating the current “Research” mode. A pull-down menu 1704 is displayed to permit a user to select and change a status associated with the inquiry request or record 1608.

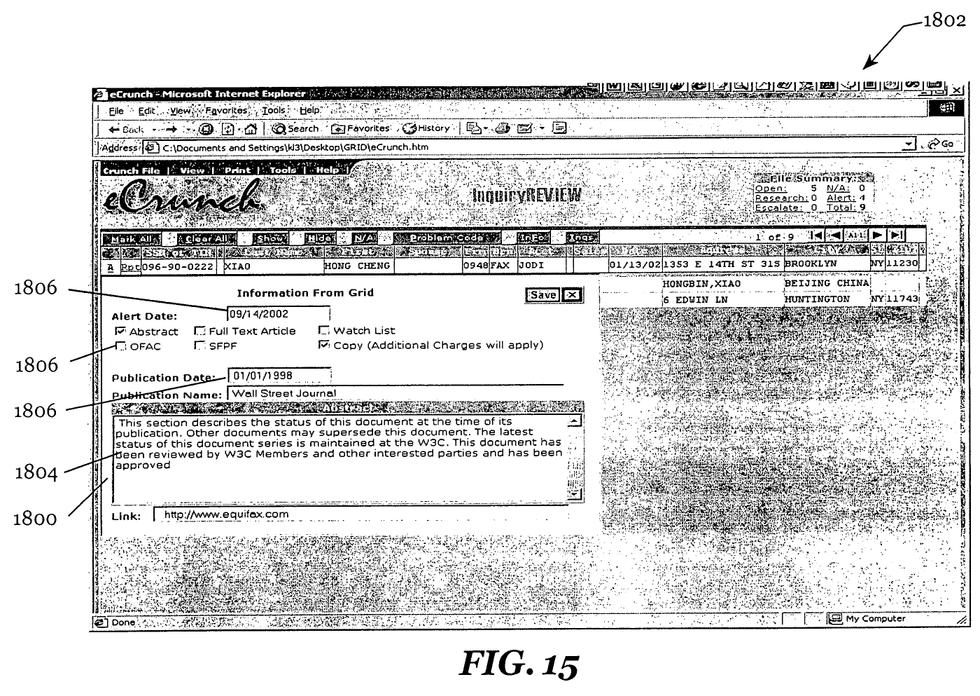

FIG. 15 illustrates a window 1800 associated with a webpage for an inquiry review. The window 1800 appears over a webpage 1802, and provides information and additional user commands for alerting a customer associated with a particular inquiry request. Referring back to the status indicator 1610 of FIG. 14, if a user decides to generate an alert for a particular inquiry request by changing the status indicator, a pop-up window 1800 appears over a portion of a current webpage 1802 or instance. The window 1800 includes a summary 1804 of relevant information relating to a particular grey file. Relevant information is typically collected by or otherwise received by a Global Information Database. For example, information that is particularly relevant to an inquiry request can be collected or received from a third-party source, an abstract generated by a Global Information Database, or a link to information accessible via a network such as the Internet.

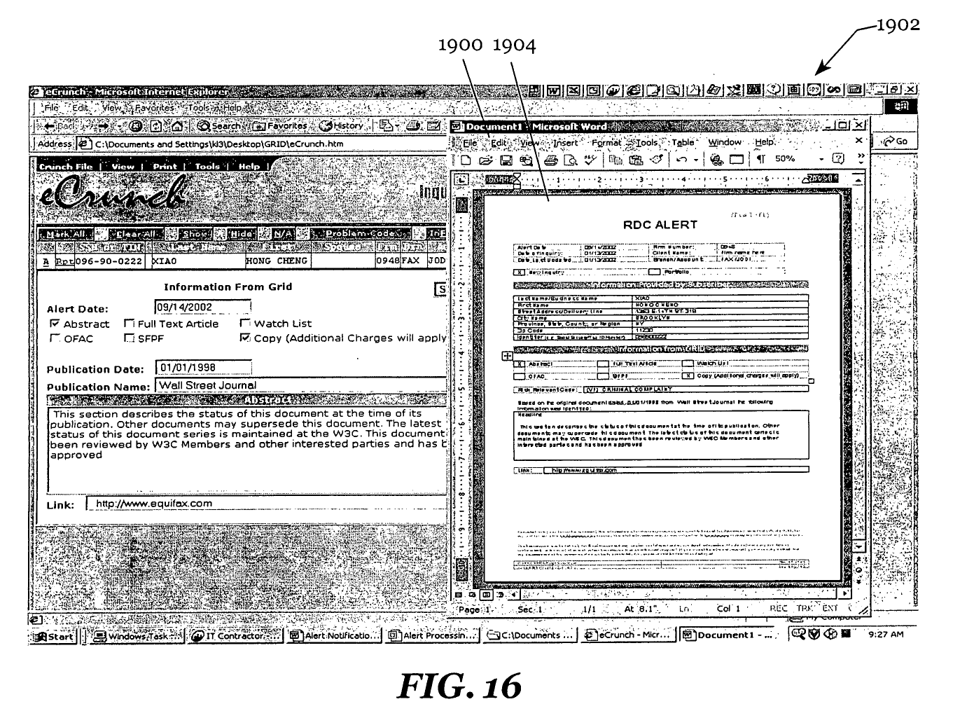

The window 1800 can include user options 1806 such as fields, check boxes, and other user interface devices to select, enter, or otherwise designate relevant information associated with the summary 1804. Relevant information associated with the summary 1804 can include, but is not limited to, an alert date, a type of information, a publication date, a publication name, an abstract, and a link to information. A user such as an alerter or supervisor can select or enter information, or the information can automatically be generated and entered into one or more fields of the summary 1804. After a user selects particular user options, or sufficient information has been entered in the summary 1804 to generate an alert, an alert can be generated such as that shown and described in FIG. 16.

FIG. 16 illustrates a window 1900 associated with a webpage 1902 for an inquiry review. The window 1900 appears over a webpage 1902, and displays a document associated with an alert generated in response to particular user options selected in FIG. 15 for a particular inquiry request. Typically, when a grey file or record is identified as containing particularly relevant information associated with a customer's inquiry request, an alert is generated with respect to the grey file or record.

In this example, an alert can be an electronic document 1904 containing information associated with the identified grey file or record. Referring back to the summary 1804 of FIG. 15, when particular user options are selected for an alert, then as shown in FIG. 16, a pop-up window 1900 appears over a portion of a current webpage 1902 or instance. The window 1900 includes an electronic document 1904 containing relevant information relating to a particular grey file. The relevant information may include previously entered information, or information associated with the electronic document 1904 or grey file. The electronic document 1904 can be generated by an associated word processing software program, or another type of software program used for creating documents, messaging, or conveying information from another location using previously defined relevant information, such as relevant information associated with the summary 1804 in FIG. 15, or information previously defined by an operator such as an alerter. Furthermore, an electronic document 1904 may be a scanned image or document previously stored in an ISYS database shown as 526 in FIG. 2, or otherwise stored by a data source accessible via a network such as 530. The electronic document 1904 can also include information provided by a customer such as an inquiry request, relevant information relating to the inquiry request, including information from one or more particularly relevant grey files, and a link to a source of the relevant information. A user can view the electronic document 1904, and further edit any of the information contained in the document 1904 prior to transmission of the document 1904 to a customer. When desired, the electronic document 1904 can be transmitted to the customer as an alert in response to a potential match to an inquiry request from the customer.

While the above description contains many specifics, these specifics should not be construed as limitations on the scope of the invention, but merely as exemplifications of the disclosed embodiments. Those skilled in the art will envision many other possible variations that within the scope of the invention as defined by the claims appended hereto.

The invention we claim is:

1. A method for administering a global information database, comprising:
gathering information from multiple data sources into a global information database, including information from a financial information database, a media information database, and an enforcement information database;
receiving an inquiry request from a customer;
comparing a name associated with the inquiry request to one or more records in the global information database;
generating a file of initial potential matches to the inquiry request;
filtering the initial potential matches to remove at least some false positives;
analyzing the file to remove at least some false positives; and
communicating an alert to the customer if at least some positive matches exist.

2. The method of claim 1, wherein receiving an inquiry request from a customer further comprises:
determining whether the inquiry request is associated with a person's name or a business name.

3. The method of claim 2, wherein determining whether the inquiry request is associated with a person's name or a business name, comprises:
isolating a name field in the inquiry request, wherein the name filed includes name information;
filtering the name information for person or business-related information; and
coding the inquiry request with a corresponding code depending on whether the name information is associated with a person or a business.

4. The method of claim 3, wherein comparing a name associated with the inquiry request to one or more records in the global information database, comprises:
comparing the name information of the inquiry request to name information in records of the database that correspond with the code of the inquiry request.

5. The method of claim 1, wherein filtering the initial potential matches to remove at least some false positives, comprises:
removing an initial potential match based on at least some of the following: a name/gender mismatch, existence of a predetermined problem code, existence of an inquiry-type record, existence of an employment-type record, a social security number mismatch with a state or predefined region, a company name mismatch with a predetermined company name, existence of a duplicate record; recency of a file exceeds a predefined time threshhold, existence of a predetermined non-FCRA alertable code, association with a firm that is no longer in business.

6. The method of claim 1, wherein analyzing the file to remove at least some false positives, comprises:
utilizing additional information from an associated database to make a determination to remove an initial potential match from the file.

7. The method of claim 1, wherein communicating an alert to the customer if at least some positive matches exist, comprises:
sending a message to the customer, including at least some of the following: a positive matching record, an article from a database, location information for information, or an abstract from a database.

8. The method of claim 1, wherein the customer communicates the inquiry request via a network, and the alert is communicated to the customer via the network.

9. A method for filtering information in response to an inquiry request to a global information database, comprising:
determining whether an inquiry request is associated with a person's name or a business name;
gathering information from multiple data sources into a global information database, including information from a financial information database, a media information database, and an enforcement information database;
searching the global information database for potential matching records to the inquiry request;
eliminating potential matching records based on whether they are a person's name or a business name;
storing potential matching records in a file;
filtering potential matching records and removing at least some false positives from the file based upon a filter; and
analyzing the file to remove at least some false positives.

10. The method of claim 9, wherein the filter of filtering potential matching records and removing at least some false positives from the file based upon a filter, comprises at least some of the following: a name/gender mismatch, existence of a predetermined problem code, existence of an inquiry-type record, existence of an employment-type record, a social security number mismatch with a state or predefined region, a company name mismatch with a predetermined company name, existence of a duplicate record; recency of a file exceeds a predefined time threshhold, existence of a predetermined non-FCRA alertable code, association with a firm that is no longer in business.

11. The method of claim 9, wherein analyzing the file to remove at least some false positives, comprises:
utilizing additional information from an associated database to make a determination to remove an initial potential match from the file.

12. A method for collecting information for a global information database, comprising:
searching multiple data sources for relevant information, including information from a financial information database, a media information database, and an enforcement information database;
generating an abstract including a portion of relevant information located from at least one of the data sources; and
storing a record including the abstract and location information of the data source with the relevant information.

13. The method of claim 12, wherein generating an abstract including a portion of relevant information located from at least one of the data sources comprises:
locating a document with relevant information;
identifying a keyword associated with the relevant information; and
creating a new document with the keyword and associated relevant information.

14. The method of claim 12, wherein the abstract includes at least some of the following: name, keyword, date, location information, copyright holder, a portion of the relevant information, or source of information.

15. A method for alerting a customer in response to an inquiry request to a global information database, comprising:
gathering information from multiple data sources into a global information database, including information from a financial information database, a media information database, and an enforcement information database;
searching the global information database for potential matching records to an inquiry request;
filtering potential matching records and removing at least some false positives;
determining a positive matching record in the global information database to the inquiry request; and
communicating an alert to the customer including a portion of information from the positive matching record.

16. The method of claim 15, further comprising:
determining whether the inquiry request is associated with a person's name or a business name;
isolating a name field in the inquiry request, wherein the name filed includes name information;
filtering the name information for person or business-related information; and
coding the inquiry request with a corresponding code depending on whether the name information is associated with a person or a business

17. The method of claim 16, wherein searching the global information database for potential matching records to an inquiry request comprises:
comparing name information of the inquiry request to name information in records of the database that correspond with the code of the inquiry request.

18. The method of claim 15, wherein filtering potential matching records and removing at least some false positives, comprises:
removing an initial potential match based on at least some of the following: a name/gender mismatch, existence of a predetermined problem code, existence of an inquiry-type record, existence of an employment-type record, a social security number mismatch with a state or predefined region, a company name mismatch with a predetermined company name, existence of a duplicate record; recency of a file exceeds a predefined time threshhold, existence of a predetermined non-FCRA alertable code, association with a firm that is no longer in business.

19. The method of claim 15, wherein communicating an alert to the customer including a portion of information from the positive matching record, comprises:
sending a message to the customer, including at least some of the following: a positive matching record, an article from a database, location information for information, or an abstract from a database.

20. The method of claim 15, wherein the customer communicates the inquiry request via a network, and the alert is communicated to the customer via the network.

21. A method for monitoring an inquiry request to a global information database, comprising:
receiving a watch list item corresponding to an inquiry request received from a customer;
detecting a record in a database matching the watch list item;
generating a file of initial potential matches to the watch list item;
filtering the initial potential matches to remove at least some false positives;
analyzing the file to remove at least some false positives; and
communicating an alert to the customer if at least some positive matches exist.

22. The method of claim 21, wherein filtering the initial potential matches to remove at least some false positives, comprises:
removing an initial potential match based on at least some of the following: a name/gender mismatch, existence of a predetermined problem code, existence of an inquiry-type record, existence of an employment-type record, a social security number mismatch with a state or predefined region, a company name mismatch with a predetermined company name, existence of a duplicate record; recency of a file exceeds a predefined time threshhold, existence of a predetermined non-FCRA alertable code, association with a firm that is no longer in business.

23. The method of claim 21, wherein analyzing the file to remove at least some false positives, comprises:
utilizing additional information from an associated database to make a determination to remove an initial potential match from the file.

24. The method of claim 21, wherein communicating an alert to the customer if at least some positive matches exist, comprises:
sending a message to the customer, including at least some of the following: a positive matching record, an article from a database, location information for information, or an abstract from a database.

25. The method of claim 21, wherein the customer communicates the inquiry request via a network, and the alert is communicated to the customer via the network.

26. A method for alerting multiple entities associated with a customer precluded from sharing information among at least some of the multiple entities, comprising:
gathering information from multiple databases into a global information database;
receiving inquiry requests from at least some of the multiple entities;
searching the global information database for potential matching records to the inquiry requests;
filtering potential matching records and removing at least some false positives;
determining positive matching records in the global information database to the inquiry requests; and
communicating a respective alert including a portion of information from the positive matching records to at least some of the multiple entities.

27. A system for administering a global information database, comprising:
a grey data enrichment module adapted to:
gather information from multiple data sources into a global information database, including information from a financial information database, a media information database, and an enforcement information database;
a global information database module adapted to:
receive an inquiry request from a customer;
compare a name associated with the inquiry request to one or more records in the global information database;
generate a file of initial potential matches to the inquiry request;
filter the initial potential matches to remove at least some false positives;
analyze the file to remove at least some false positives; and
communicate an alert to the customer if at least some positive matches exist.

28. A system for alerting multiple entities associated with a customer precluded from sharing information among at least some of the multiple entities, comprising:
a grey data enrichment module adapted to:
gather information from multiple databases into a global information database;
a global information database module adapted to:
receive inquiry requests from at least some of the multiple entities;
search the global information database for potential matching records to the inquiry requests;
filter potential matching records and removing at least some false positives;
determine positive matching records in the global information database to the inquiry requests; and
communicate a respective alert including a portion of information from the positive matching records to at least some of the multiple entities.

29. A method for processing multiple crunch files containing name-associated information, the crunch files having been pre-processed at least partially to identify and eliminate at least some false positive information, comprising:
receiving one or more crunch files in a queue;
prioritizing the crunch files;
distributing the crunch files from the queue to a respective alerter queue based upon the priority of each crunch file;
analyzing a crunch file in a particular alerter queue to identify false positive information in the crunch file; and
if remaining information positively matches a customer's inquiry request, generating an alert to a customer with the matching information.

30. The method of claim 29, wherein at least some of the crunch files originate from at least one of multiple data sources accessible by a global information database.

31. The method of claim 29, wherein at least some of the crunch files include an abstract file stored in a global information database.

32. A system for processing multiple crunch files from at least one customer, wherein the crunch files have been pre-processed at least partially to identify and eliminate at least some false positive information, comprising:
an incoming file queue adapted to receiving one or more crunch files;
a supervisory station adapted to,
prioritize the crunch files, and
distribute the crunch files from the incoming queue to a respective alerter queue based upon the priority of a crunch file; and
an alerter station adapted to,
analyze a crunch file in a respective alerter queue to identify false positive information; and
generate an alert to a customer if remaining information matches a customer's inquiry request.
